(19) United States
(12) Patent Application Publication
(10) Pub. No.: US 2014/0311967 A1
(43) Pub. Date: Oct. 23, 2014

(54) POROUS MATERIALS AND METHODS INCLUDING NANOPOROUS MATERIALS FOR WATER FILTRATION

(71) Applicant: Massachusetts Institute of Technology, Cambridge, MA (US)

(72) Inventors: Jeffrey Grossman, Brookline, MA (US); Nicola Ferralis, Cambridge, MA (US); David Cohen-Tanugi, Cambridge, MA (US); Shreya H. Dave, Cambridge, MA (US)

(73) Assignee: Massachusetts Institute of Technology, Cambridge, MA (US)

(21) Appl. No.: 14/210,953

(22) Filed: Mar. 14, 2014

Related U.S. Application Data
(60) Provisional application No. 61/788,438, filed on Mar. 15, 2013.

(51) Int. Cl. B01D 71/02; C02F 1/44; C08J 9/26; C01B 31/04; B82Y 30/00

(52) U.S. Cl. CPC B01D 71/021; C01B 31/0446; B82Y 30/00; C08J 9/26; C02F 1/442
USPC 210/500.21; 423/448; 427/243; 427/244; 432/13

(57) ABSTRACT

Embodiments described herein relate to porous materials that may be employed in various filtration, purification, and/or separation applications. In some cases, the porous materials may be thin, flexible, and fabricated with control over average pore size and/or the spatial distribution of pores. Such porous materials may be useful in, for example, desalination.

### RELATED APPLICATIONS

This application claims priority under 35 U.S.C. §119(e) to co-pending U.S. Provisional Application Ser. No. 61/788,438, filed Mar. 15, 2013, the contents of which are incorporated herein by reference in its entirety for all purposes.

### FIELD OF THE INVENTION

Embodiments described herein relate to porous materials, and related methods and devices.

### BACKGROUND OF THE INVENTION

Desalination is a promising approach to supply new fresh water in the context of a rapidly growing global water gap. Although oceans and seas contain about 97% of the world's water, desalination only accounts for a fraction of a percent of the world's potable water supply, in part, because existing commercial techniques for desalination suffer from important drawbacks, including large energy footprints and high capital costs. Reverse osmosis (RO) is an energy-efficient desalination technique with 1.8 kWh/m³ achieved in a commercial plant (compared with an average ˜5 kWh/m3 in the 1990s). By contrast, thermal desalination methods such as multistage flash and multiple-effect distillation are often several times more energy-intensive.

Nanoporous materials have many advantages over existing technologies for desalination. In contrast with classical reverse osmosis membranes, where water transports slowly via a solution diffusion process, nanoporous membranes can allow for fast convective water flow across well-defined channels. Due to their small dimensions, nanopores can be used as filters on the basis of molecular size since small molecules can pass through them while larger ones cannot. Additionally, because the dimensions of the nanopores are also comparable to the Debye screening length for electrostatic interactions and smaller than the mean free path between molecular collisions in water, the pores can also make use of other physical principles, such as charge or hydrophobicity, to reject ions or other molecular solutes. Nanofluidics studies of synthetic nanostructures such as carbon nanotubes (CNTs) suggest that water inside such structures can exhibit “hyperlubricity” and flow at rates greater than predicted by continuum fluid dynamics. Metal-organic frameworks (MOFs) such as zeolites have also been examined for desalination technology. However, such nanomaterials have also displayed drawbacks including low salt rejection rates and low water permeability. Also, producing highly aligned and high density CNT arrays has been difficult.

### SUMMARY OF THE INVENTION

Various materials, and methods for fabricating materials, are provided. In some embodiments, the material is a porous material.

In some embodiments, the method comprises providing a material having a first side and a second, opposing side; creating a plurality of pores in the material, the plurality of pores spanning the material from the first side to the second, opposing side, and having an average pore size greater than 1 nanometer; attaching a moiety to the sidewalls of the pores to produce a porous material comprising a plurality of pores having an average pore size of 1 nanometer or less.

In some embodiments, the method comprises providing a porous material precursor and a fullerene species substantially contained within the porous material precursor, the fullerene species having a diameter; treating the porous material precursor to remove the fullerene species, thereby producing a porous material comprising a plurality of pores having an average pore size that is substantially similar, or essentially identical, to the diameter of the fullerene species.

In some embodiments, the method comprises exposing a graphene oxide material to a set of reducing conditions to produce a porous graphene material comprising a plurality of pores; and arranging the porous graphene material as a filtration material.

Materials are also provided comprising a substrate that is substantially free of pores having a pore size of 5 microns or greater; and a porous material (e.g., graphene material) arranged on a surface of the substrate. In some cases, the material exhibits a mechanical stability characterized by a fracture stress of about 100 GPa or greater when placed under a pressure of about 1 MPa or greater.

### BRIEF DESCRIPTION OF THE DRAWINGS

FIG. 1 shows a representative atomic structure of nanoporous graphene, with the scale bar indicating 10 Å.

FIG. 2 shows (a) a schematic representation of thermal oxide growth of a material to reduce pore diameter and (b) a schematic representation of the introduction of a self-assembled monolayer within a pore to reduce pore diameter.

FIG. 3 shows computational images of (a) hydrogenated and (b) hydroxylated graphene pores, as well as (c) a side view of a computational system used to study the filtration of an aqueous solution containing NaCl through a porous graphene material.

FIG. 4 shows a plot of water flow in hydroxylated pores as a function of simulation time, with flow rates, given by the slope of each curve, increasing as a function of applied pressure as well as pore size and the largest pores allowing water to flow at a constant rate that was proportional to applied pressure until the entire feed reservoir was depleted.

FIG. 5 shows a plot of computed water permeability for nanoporous graphene functionalized with hydrogen and hydroxyl groups for various pore sizes, with water permeability scaling roughly linearly with the area of hydroxylated or hydrogenated pores.

FIG. 6 shows the average salt rejection as a function of pore type and pressure differential, indicating that smaller pores may be capable of effectively rejecting salt with rejection performance decreasing at higher pressures, and that hydrogenated pores may exhibit a stronger salt rejection performance than hydroxylated ones.

FIG. 7 shows oxygen density maps for the inside of hydrogenated (left) and hydroxylated (right) pores, with open pore areas of 23 Å² and 28 Å² respectively.

FIG. 8 shows the angular distribution function (ADF) of water molecules with respect to the plane of the graphene membrane as a function of position, with increasingly positive values of cos(α), shown as darker regions, indicating that the molecule's hydrogen atoms lie toward the membrane, and lighter regions indicating negative values. (ADF was averaged over 5 Å on the feed side of the membrane.)

FIG. 9 shows the predicted salt rejection across a hydrogenated (upper line) and hydroxylated (lower line) pore from a simple kinetic model, with the model qualitatively replicating the observed decrease in salt rejection with increasing pressure, as well as the higher salt rejection performance of a hydrogenated pore (neglecting certain features of the MD system, including osmotic effects, finite size effects, and collective phenomena), indicating that hydrophilic membrane chemistries enable can faster flow rates by increasing the range of conformations and bonding configurations allowed inside the pore.

FIG. 10 shows a performance chart for functionalized nanoporous graphene versus existing technologies, with the graphene nanopores capable of rejecting salt ions with a water permeability 2-3 orders of magnitude higher than commercial reverse osmosis. Data for reverse osmosis and MFI zeolites adapted from Pendergast et al., Energy Environ. Sci. 2011, 4, 1946-1971, the contents of which are incorporated herein by reference for all purposes.

FIG. 11 shows (a) a schematic representation of the arrangement of a nanoporous graphene (NPG) membrane supported by a substrate with cavities on the lengthscale of 0.2 μm, with the inset showing the predicted mechanical loading on a patch of graphene due to applied pressure in a reverse osmosis system; and (b) a molecular visualization of a hydrogenated NPG, with pores having a radius of 0.5 nm and separated by approximately 2.4 nm Scale bar indicates 10 Å.

FIG. 12 shows the stress distribution in an NPG sheet during failure (22% strain, 75.3 GPa), with stress at each atom is represented by its color, with darker regions corresponding to the areas of highest stress; the stress near the pores is about 1.5 higher than the stress away from the pores.

FIG. 13 shows (a) a graph of the maximum hydraulic pressure before membrane failure as a function of NPG patch size; and (b) a graph of the maximum patch size as a function of pore separation for a layer of NPG exposed to ΔP=1, 5 and 10 MPa.

FIG. 14 shows (a) a graph of the global stress in an NPG membrane as a function of applied strain, and (b) a graph of the stress concentration factor (SCF), measured as the ratio of stresses in atoms at the pore edge vs. away from pores.

FIG. 15 shows (a) a graph of the effect of pressure on the flux across a GE Osmonics AG brackish water membrane; and (b) a graph of the effect of the use of a magnetic stir bar to maintain well mixed conditions and prevent the accumulation of salt at the surface of the membrane.

FIG. 16 shows (a) an SEM image of an anodized aluminum membrane with assymetric pores; (b) a histogram showing pore size distribution; and (c) high resolution transmission electron microscopy image of the crystal lattice of a gold nanoparticle.

FIG. 17 shows (a) a schematic representation of a surface modified-graphene oxide reverse osmosis membrane; (b) the membrane (i) spin-coated onto a pre-conditioned GE Osmonics AG membrane and (ii) after its use in filtering 0.3% NaCl solution; and (c) a graph of the stability of the membranes under various conditions including (i) pre-conditioned but unmodified, (ii) preconditioned and rested in DI water overnight, (iii) surface treated with GO solution, and (iv) surface treated with GO solution and rested in DI water overnight.

FIG. 18 shows (a) (left) a molecular dynamics simulation of a single layer of graphene oxide that has been reduced in order to remove surface oxygen, and (right) a histogram of the nanopore size distribution in graphene oxide, as measured by the open area (in Å²) of each pore, and (b) (i) a TEM image of reduced graphene oxide flake on a holey carbon gold TEM grid and (ii) rGO dispersed in toluene spin-coated onto a GE Osmonics AG membrane.

FIG. 19 shows SEM images of amorphous silicon (a) with 182 nm+/−3 nm pores patterned using interference lithography, and after high frequency silicon oxide deposition, reducing the pore size to (b) 128 nm or (c) 38 nm; (d) a cross-sectional image of the pores; and (e) another cross-sectional image of the pores.

FIG. 20 shows SEM images of alumina mounted on carbon tape (a) prior to hydrothermal treatment, and upon hydrothermal treatment for (b) five, (c) ten, and (d) thirty minutes.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

Embodiments described herein relate to porous materials that may be employed in various filtration, purification, and/or separation applications. For example, methods described herein may provide the ability to fabricate porous materials that are able to exclude or reject various species including salt ions while allowing fluids to flow at permeabilities several orders of magnitude higher than current membranes (e.g., up to 500× more than existing membranes). Some embodiments provide thin (e.g., less than 40 microns in thickness), flexible, porous nanostructures (e.g., graphene) that may be useful in, for example, desalination. Methods described herein may also provide the ability to fabricate porous materials with control over average pore size and/or the spatial distribution of pores.

In some cases, the porous materials may employ size exclusion, electrostatic interactions, and/or chemical interactions to facilitate the filtration or separation of various species and molecular solutes from solutions (e.g., aqueous solutions). The porous materials may be fabricated using a variety of materials, including metal-containing materials, nanostructured carbon materials (e.g., graphene, graphene oxide), other inorganic or organic materials, and the like. Typically, the porous materials may contain pores having an essentially circular cross-sectional profile. However, it should be understood that pores having different cross-sectional profiles or shapes may also be formed, as described more fully below.

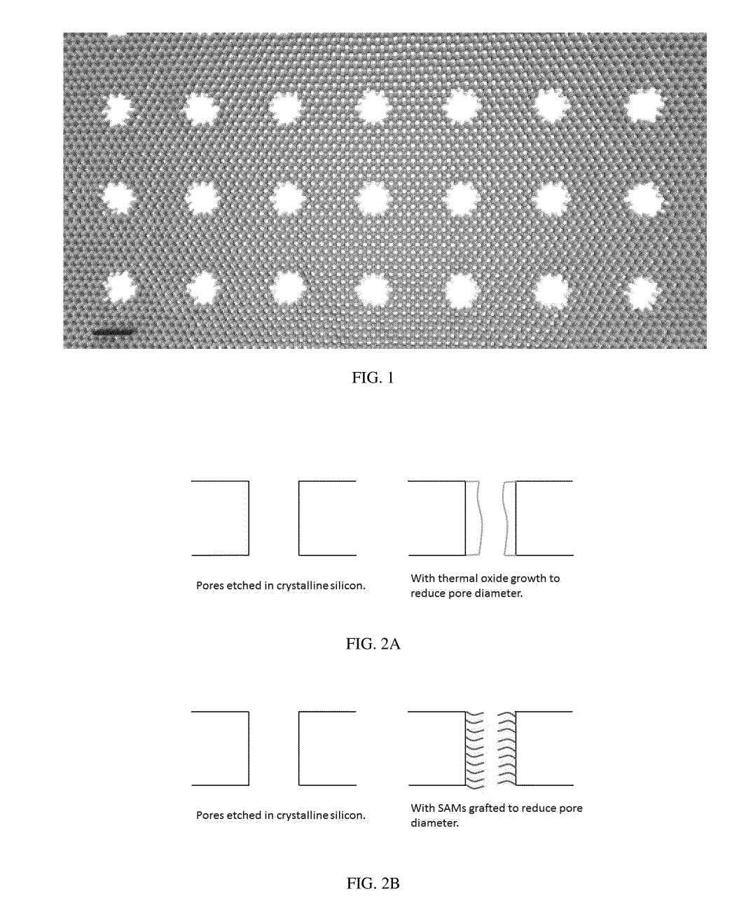

In one set of embodiments, the porous material may primarily comprise a nanostructured carbon material, such as carbon nanotubes, graphite, graphene, or graphene oxide. In some cases, the porous material is a porous graphene material. As shown in the illustrative embodiment in FIG. 1, a porous graphene material (e.g., nanoporous graphene material) may include a plurality of homogeneously distributed pores, each having a substantially circular cross-sectional profile. In other embodiments, the porous material may primarily comprise a metal-containing material. The metal-containing material may be for example, any suitable metal, metal oxide(s), and/or metal nitride(s). In some cases, the metal-containing material comprises SiN, SiO₂, Al₂O₃, TiO₂, and/or TiN. In one set of embodiments, the metal-containing material comprises silicon (e.g., silicon, silicon dioxide, or amorphous silicon).

The porous material may be fabricated to have pores with an average pore size that can effectively reject certain species (e.g., ions such as Na⁺ and Cl⁻) while allowing other species (e.g., fluid molecules such as water) to enter and flow through the pores. In some embodiments, the porous material (e.g., porous graphene material) may be fabricated to include a plurality of pores having an average pore size of about 1 nm or less (i.e., 10 Å or less). For example, the porous material may include a plurality of pores having an average pore size of about 6 Å to about 9 Å. In some embodiments, the porous material includes a plurality of pores having an average pore size of about 7 Å to about 9 Å. As used herein, the average pore size refers to the average diameter of the pores, measured from the center of an atom on the edge of the pore to the center of an atom on the other, opposing edge of the pore. In some embodiments, the pores may be substantially symmetric (e.g., the diameter of the pores may be substantially the same throughout the pores). In some embodiments, the pores may be asymmetric (e.g., the diameter of the pores may vary throughout the pores). Pore size may be determined microscopically, for example using either or both of transmission electron microscopy (TEM) or scanning electron microscopy (SEM), and/or by X-ray diffraction (XRD), and refers to the length of the shortest line parallel to a surface of the porous material connecting two points (e.g., centers of two atoms) around the circumference of a pore and passing through the geometric center of the pore opening (e.g., the diameter of the pore opening).

It should be understood that porous materials having relatively larger average pore sizes (e.g., greater than 1 nm) may also be useful in the context of various embodiments described herein. For example, it may be desirable in a particular application to achieve partial filtration of a solution (e.g., less than 100% rejection of a species from the pores). In some cases, the average pore size may be selected to achieve total or partial filtration of relatively larger species (e.g., species having a at least one dimension diameter greater than 1 nm). In some embodiments, at least 50%, at least 60%, at least 70%, at least 80%, at least 90%, at least 95%, or at least 99% of a particular species (e.g., a salt) is excluded from or rejected by the pores. Those of ordinary skill in the art would be capable of selecting and fabricating porous materials having a particular average pore size to achieve a particular desired result, using methods described herein. In some embodiments, the average pore size suitable for excluding a particular species may be selected based at least in part on the size of the water solvation shell of the species.

In some cases, porous materials having a relatively narrow pore size distribution are provided. In some embodiments, the porous material may be constructed to have a relatively homogeneous pore size distribution, for example such that no more than about 50%, about 45%, about 40%, about 35%, about 30%, about 25%, about 20%, about 15%, about 10%, about 5%, or about 1% of all pores deviate in size from the average pore size by more than about 10%, in some cases, by no more than about 5%.

Pore size may also be described in terms of average pore area (Å²), that is, the average open area within a pore through which a species can travel. In some embodiments, the pores may have an average pore area in the range of about 1 Å² to about 100 Å², about 1 Å² to about 95 Å², about 1 Å² to about 90 Å², about 1 Å² to about 85 Å², about 1 Å² to about 80 Å², about 1 Å² to about 75 Å², about 1 Å² to about 70 Å², about 1 Å² to about 65 Å², about 1 Å² to about 60 Å², about 1 Å² to about 55 Å², or about 1 Å² to about 50 Å². In some cases, the pores may have an average pore area in the range of about 1.5 Å² to about 62 Å². In certain embodiments, the average pore area may be affected by any chemical functional groups present within the pores and/or at or near a terminal end of the pore (e.g., pore edge). As an illustrative embodiment, a pore containing hydrogen groups attached to the pore sidewalls, and/or at or near the pore edges, may have a pore area of about 23.1 Å². In another embodiments, a pore containing hydroxyl groups attached to the pore sidewalls, and/or at or near the pore edges, may have a pore area of about 16.3 Å².

In some embodiments, the porous materials may be appropriately chemically functionalized in order to enhance performance as a filtration material. For example, the surface chemistry of the pores can be tuned to enhance the flow of a fluid such as water and/or to improve the rejection of various species, such as ions. As an illustrative embodiment, carbon atoms at the pore edges of a porous graphene molecule can be bonded to a wide variety of functional groups, including hydrophilic groups (such as hydroxyl, unsubstituted or substituted amino, or the like) or hydrophobic groups (such as hydrogen, alkyl, aryl, or the like). The relative hydrophobicity or hydrophilicity of functional groups positioned at or near the pore edges or entrances can affect the ability of species to permeate the porous material.

In one set of embodiments, atoms at the pore edges of the pore material may be substituted with one or more hydrophobic groups. Such functionalization may allow for improved permeation of species that are compatible with the hydrophobic groups into the pores, as well as improved rejection of species (e.g., salts) that may not be compatible with the hydrophobic groups. In another set of embodiments, atoms at the pore edges of the pore material may be substituted with one or more hydrophilic groups. Such functionalization may allow for improved permeation of species that are compatible with the hydrophilic groups into the pores, as well as improved rejection of species (e.g., salts) that may not be compatible with the hydrophilic groups.

For example, in the filtration of aqueous solutions, functionalization at or near the pore edges of the porous material can affect the number of available configurations for water molecules and any solutes present as they approach and/or enter the pores. In some cases, hydrophobic functionalization at or near the pore edges can restrict the number of available configurations to salt ions, thereby increasing the overall free-energy barrier for salt passage at room temperature. In some cases, the pore edges may include hydrogen groups at or near the pore edges, which may allow for enhanced salt rejection but may also reduce water flow through the pores by imposing additional conformational order on the system and restricting the number of hydrogen-bonding configurations available to water molecules traversing the membrane. By contrast, hydrophilic functionalization (e.g., with hydroxyl groups) at or near the pore edges can provide a relatively smoother entropic landscape for water molecules to traverse, thus allowing for faster overall water flow.

In some cases, both pore size and chemical functionalization of the pores may affect performance of the porous material. For example, the level of exclusion or rejection achieved by nanoporous graphene may be affected by the average size of its pores. In some cases, the appropriate average pore size for excluding or rejecting a specific type of species (or solute) may be related to the vdW or solvated diameter of the species, as well as the chemical affinity between the species and the pore edge or entrance.

Porous materials described herein may be fabricated to have a thickness suitable for use in a particular application. In some embodiments, the porous materials may be relatively thin (e.g., 40 microns or less). In some cases, the porous material includes at least one portion having a thickness in the range of about 1 micron to about 40 microns, about 1 micron to about 30 microns, about 1 micron to about 20 microns, about 1 micron to about 10 microns, or about 1 micron to about 5 microns. In some cases, the porous material includes at least one portion having a thickness of less than about 1 micron, less than about 0.1 micron, less than about 0.01 micron, less than about 0.001 micron, or less than about 0.0001 micron.

In some cases, the porous material includes at least one portion having a thickness of in the range of about 0.1 nm to about 500 nm, as measured between a first side of the porous material and a second, opposing side of the porous material. In some cases, the porous material includes at least one portion having a thickness of less than about 500 nm, less than about 400 nm, less than about 300 nm, less than about 200 nm, less than about 100 nm, less than about 50 nm, less than about 25 nm, less than about 10 nm, less than about 5 nm, less than about 1 nm, or, in some cases, less than about 0.1 nm, as measured between a first side of the porous material and a second, opposing side of the porous material. In some embodiments, the porous material comprises at least one portion having a thickness of about a single atomic layer, as measured between a first side of the porous material and a second, opposing side of the porous material.

The porous material may have an overall porosity of about 10%, about 20%, about 30%, about 40%, about 50%, about 60%, about 70%, about 80%, about 90%, or greater. In some cases, the porous material may have an overall porosity of about 25%. The porous material may have a desired pore distribution or pore density (e.g., substantially uniform, or non-uniform) across the longitudinal dimension of the membrane in order to, for example, modulate flux polarization, reduce fouling, and otherwise improve performance of the membrane. In some embodiments, the pore density may be non-uniform. In some embodiments, the pore density may be substantially uniform.

Porous material described herein may exhibit a number of improved performance characteristics. In some embodiments, porous materials described herein may exhibit enhanced water permeability and/or solute selectivity, and may provide several advantages over known technologies. For example, for a given water output, a porous material having enhanced water permeability may enable lower energy requirements due to lower operating pressures. Additionally, increased water permeability may decrease the area of porous material required, allowing for relatively smaller, more modular desalination plants. As an illustrative embodiment, nanoporous thin-film materials such as nanoporous graphene may have a negligible thickness compared to existing technologies, and may possess well-defined pores that allow for rapid water flow, resulting in enhanced water permeability. As used herein, “water permeability” refers to the amount of water flux through a porous material per unit of driving pressure.

In some embodiments, the porous material has a water permeability in the range of about 0.1 to about 300 L/cm²/day/MPa, about 1 to about 200 L/cm²/day/MPa, about 25 to about 100 L/cm²/day/MPa, about 30 to about 70 L/cm²/day/MPa, or about 40 to about 60 L/cm²/day/MPa. In some embodiments, the porous material has a water permeability in the range of about 36 to about 66 L/cm²/day/MPa. In one set of embodiments, nanoporous graphene materials having an overall porosity of 10% and containing a plurality of pores having an average pore size of about 6 Å may exhibit a water permeability of about 50 L/cm²/day/MPa to about 60 L/cm²/day/MPa, which is two to three orders of magnitude higher than known UF, NF and reverse osmosis membranes.

Materials are also provided including a porous material as described herein (e.g., a graphene material) arranged in combination with a support material or a substrate. For example, the porous material may be arranged or formed on the surface of a substrate. The substrate may be selected to provide sufficient mechanical support for the porous material (e.g., active layer). In cases where the porous material/substrate is arranged as a filter for fluids, the substrate may bear much of the hydraulic load while distributing the pressure from the fluid (e.g., water) onto portions of the porous material. In some embodiments, the substrate may be selected to provide sufficient mechanical strength and/or fracture strength to support the porous material during use. For example, the substrate may be selected to be substantially free of pores (e.g., pores, cavities) having a pore size of about 5 microns or greater. For example, the substrate may be selected to have less than 10%, less than 5%, or in some cases, less than 1% of pores having a pore size of about 5 microns or greater. In some cases, the substrate may be selected to be substantially free of pores (e.g., pores, cavities) having a pore size of about 1 micron or greater. That is, the substrate may have less than 10%, less than 5%, or in some cases, less than 1% of pores having a pore size of about 1 micron or greater. It may also be desirable for the substrate to have a relatively narrow pore size distribution.

The substrate may also be selected to have sufficient adhesion interaction with the porous material, such that the porous material does not delaminate or otherwise separate from the substrate during use. In some cases, the substrate and porous material may interact via covalent bonding, or hydrogen bonding, van der Waals forces, or other non-covalent interactions. Heat treatment and texturing may also be employed to increase the adhesion interaction between the substrate and porous material. The substrate may also be selected to have the appropriate surface stickiness, flexibility, mechanical resistance, edge sharpness, and other characteristics, to be suitable for use as a membrane.

Examples of substrate material include, but are not limited to, polysulfone, polycarbonate, etched copper in combination with a polymer, mixed cellulose ester substrates (pore size ˜200 nm), Teflon® (PTFE), copper, silicon, silicon dioxide, and the like. In some embodiments, a material comprising a graphene material arranged on a substrate as described herein may be capable of withstanding hydraulic pressures upwards of 50 MPa, over 10 times more than in typical seawater RO operations today.

In some cases, the material may exhibit a mechanical stability characterized by a fracture stress of about 100 GPa or greater when placed under a pressure of about 1 MPa or greater. In some cases, the material may exhibit a mechanical stability characterized by a fracture stress of about 150 GPa, about 200 GPa, about 250 GPa, about 300 GPa, about 350 GPa, about 400 GPa, about 450 GPa, about 500 GPa, or greater, when placed under a pressure of about 1 MPa. In some cases, the material may exhibit a mechanical stability characterized by a fracture stress of 100 GPa or greater when placed under a pressure of about 1 MPa, about 10 MPa, or greater.

In some cases, the material contains a graphene material arranged on a substrate. In some embodiments, the material includes a single-layer of the graphene material. In some embodiments, the material includes multiple layers of the graphene material.

As described herein, the porous material may be designed and fabricated to achieve a desired degree of filtration, or species rejection. In some embodiments, the porous material may exhibit a species rejection in the range of about 30% to about 100%, about 40% to about 100%, about 50% to about 100%, about 60% to about 100%, about 70% to about 100%, about 80% to about 100%, or about 90% to about 100%, upon contact with a solution comprising a species. In some embodiments, the porous material exhibits a species rejection in the range of about 99% upon contact with a solution comprising a species. In some embodiments, the porous material exhibits a species rejection in the range of about 100% upon contact with a solution comprising a species. In an illustrative embodiment, a nanoporous graphene material with appropriately sized pores may be capable of rejecting close to 100% of salt (e.g., NaCl) in an aqueous solution.

Another advantageous feature of materials and methods described herein is enhanced resistance to fouling. Fouling refers to the gradual accumulation of undesired matter on the surface of a porous material, and has been shown to occur on materials having relatively rough topographies and/or on oxygen-containing surfaces that favor organic matter growth. Some embodiments described herein provide materials (e.g., porous graphene-based materials) having a smooth, hydrophobic surface that can present improved resistance to fouling, resulting in longer plant uptime, longer life of the porous material or membrane, lower driving pressures, and the like. Porous materials described herein may also exhibit a high resistance to corrosive and reactive chemicals, including chlorine. This may reduce or eliminate the need to spend time and financial resources removing any traces of chlorine from the feed water to avoid damaging polymer membranes.

In some embodiments, porous materials described herein may advantageously operate at lower driving pressures, reducing energy consumption. For example, a porous material fabricated using methods described herein may have relatively higher water flux at a given driving pressure, i.e., the porous material may produce more water per day while keeping the energy requirements per liter unchanged. In some cases, water output gains may become increasingly significant at lower solute concentrations. Such porous materials can reduce overall energy consumption, as well as the cost of operating various production plants (e.g., water production plants). For example, standard daily water requirements may be achieved using fewer and/or smaller membrane elements (e.g., porous materials), pressure vessels, pipes, pumps, sensors and other skid equipment. These output gains could also reduce the size footprint of a NF/UF/reverse osmosis system, making the porous materials attractive for applications where space or weight is a critical resource.

In some cases, the porous material may be utilized in the filtration of various solutions, including aqueous solutions such as seawater, brackish water, water from hydraulic fracturing (fracking) and other mining operations, or other waste water. For example, a solution comprising a fluid carrier and a plurality of species may be placed in contact with a first side of the porous material. As described herein, the porous material may contain pores that are sized and/or chemically functionalized to substantially prevent at least a portion of the species from traversing the porous materials through the pores, i.e., flowing from the first side of the porous and to a second, opposing side of the porous material through the pores. The solution may include one or more types of species. In some cases, the species may include a charged species (e.g., an ion). For example, the species may include one or more metal ions, including heavy metal ions. In some cases, the species may be a highly toxic contaminant such as arsenic or chromium ions. In some cases, the species may be an inorganic salt (e.g., NaCl), an organic salt, or an organometallic salt. In some cases, the species may be an uncharged species, such as boron.

Some examples of specific species include, but are not limited to, halide ions (e.g., chloride ions), ions of sodium, arsenic, mercury, calcium, magnesium, radium, barium, strontium, and other metals, bromide-containing compounds including, but not limited to, bromate, boron-containing compounds including, but not limited to, boric acid and borate, sulfates, carbonates, naturally occurring radioactive materials including, but not limited to, antimony-121, antimony-122, antimony-123, antimony-124, antimony-125, antimony-126, antimony-127, chromium-51, cobalt-57, cobalt-58, cobalt-60, gold-198, iodine-127, iodine-128, iodine-129, iodine-130, iodine-131, iridium-192, iron-59, krypton-85, lanthanum-140, potassium-39, potassium-40, potassium-41, potassium-42, potassium-43, rubidium-86, scandium-45, scandium-46, scandium-47, scandium-48, silver-110, strontium-85, xenon-133, zinc-65, and zirconium-95, colloidal solids, and the like.

In some cases, the porous material may be configured and arranged for the desalination of water. For example, porous materials (e.g., nanoporous thin films) as described herein may enable a series of new devices and processes beyond the cylindrical cross-flow systems typically employed in NF/UF/reverse osmosis. In some cases, increased water permeability and fouling/scaling resistance can allow for the use of dead-end filtration modules in which the direction of feed water flow is perpendicular to the membrane surface, rather than parallel to it as in cross-flow systems, with advantages for water recovery, system footprint, and energy consumption. In addition, the relatively higher permeability of porous material described herein may allow for large-scale and economical application of shear-enhanced membrane filtration, a process in which membranes are coupled to a rotating or vibrating device in order to increase the shear rate at the water-membrane interface, thereby reducing the effects of concentration polarization. In some cases, the high permeability of nanoporous thin-film membranes may enable the use of shear-enhanced systems with high water throughput with reduced membrane area and correspondingly small devices.

Methods for fabricating the porous materials described herein are also provided. In one set of embodiments, the method may involve creating a set of pores within a material, followed by functionalization of the pore sidewalls to effectively reduce the average pore size to suit a particular application. For example, a plurality of pores having an average pore size greater than 1 nanometer may be formed in a material such as a metal-containing material or a carbon-based material. In some embodiments, the material may include pores having an average pore size in the range of about 1 nm to about 500 nm, about 1 nm to about 100 nm, or about 1 nm to about 10 nm.

The pores may be formed within a material using a variety of methods, including interference lithography, electron beam lithography, templating using block copolymers (e.g., wherein certain domains are removed to yield pores), reactive ion etching (RIE) and metal-induced etching (MIE). The plurality of pores formed may be substantially consistent in size, size distribution, shape, and surface properties. For example, using microfabrication techniques known to those of ordinary skill in the art, the cross-sectional shape (circular, oval, triangular, irregular, square or rectangular, or the like), number, and dimensions of the pores can be varied to suit a particular application. A variety of suitable or potentially suitable microfabrication techniques are discussed in, for example, Silicon processing for the VLSI Era, 2nd Ed., Vol. 1, S. Wolf and R. N. Tauber, Lattice Press, Sunset Beach, Calif. (2000); M. J. Bowden, “A Perspective on resist Materials for fine line lithography”, in Materials for Microlithography, Advances in chemistry Series, #266, American Chemical Society, Washington, D.C., Chap. 3, p. 39-117 (1984); D. Nyyssonen, “Optical Linewidth Measurement on Patterned Wafers,” SPIE proceedings, Vol. 480, Integrated Circuit Metrology, p. 65 (1984); and J. D. Cuthbert, “Optical Projection Printing,” Solid State Technology, P. 59, August 1977; each of which is incorporated by reference in its entirety for all purposes. In one set of embodiments, the pores may have an essentially circular cross-sectional profile.

Next, one or more moieties may be attached to the sidewalls of the pores, and/or at or near the pore edges, to produce a plurality of pores having a reduced average pore size. In some cases, the average pore size may be reduced to 1 nanometer or less. The pores may be functionalized with a range of materials, including metal-containing species, organic compounds (e.g., small molecules, polymers, etc.), and the like. In one set of embodiments, the material may be a metal-containing material such as silicon and the sidewalls of the pores may be exposed to a set of thermal oxidation conditions to reduce the average pore size. (FIG. 2A) In some cases, the average pore size may be reduced to 1 nm or less. Those of ordinary skill in the art would be capable of selecting the appropriate set of conditions for oxide growth, including growth time, temperature, and concentration, in order to reduce the size of the holes to their specific and desired diameter.

In another set of embodiments, self-assembled monolayers (SAMs) may be attached (e.g., grafted) to the pore sidewalls, and/or at or near the pore edges, in order to tailor the size, electrostatic charge, surface properties, or other characteristic of the pore to suit a particular application. (FIG. 2B) In some cases, SAMs may be selected to exhibit certain desired hydrophobic and/or hydrophilic properties. Advantageously, SAMs may be physically distributed throughout the pores such that sufficient stiffness may be maintained to effectively modulate the average pore diameter. In some embodiments, the SAM comprises a fatty acid, an organosilicon compound, or an organosulfur compound. In some cases, the SAMs may include compounds having hydroxyl, amino, carbonyls (e.g., carboxylic acids), thiols, ethers, thioesters, —Si—O— groups, or the like. Some examples of SAMs and methods for appending SAMs on a particular material are disclosed in Ulman, A., “Formation and Structure of Self-Assembled Monolayers,” Chem. Rev. 1996, 96, 1533-1554, the contents of which are incorporated by reference in its entirety for all purposes. In another set of embodiments, the porous materials may be fabricated by use of a template species to create pores having a particular desired average pore size, as well as a desired location and spatial distribution within the material. For example, the method may involve use of a porous material precursor (e.g., a metal-containing material such as copper or nickel, a carbon-based material, etc.) and a template species substantially contained within the porous material precursor. The template may have a particular diameter, such that treatment of the porous material precursor to remove the template species produce a porous material comprising a plurality of pores having an average pore size that is substantially similar, or essentially identical, to the diameter of the template species. Treatment of the porous material precursor may involve, for example, heating, etching, exposure to a chemical reagent, exposure to electromagnetic radiation, exposure to other sources of external energy, or the like. In some cases, a chemical moiety may be attached to the sidewalls, and/or at or near a terminal end, of the resulting pores, as described herein.

For example, the template species may be a fullerene species. As used herein, the term “fullerene” or “fullerene species” is given its ordinary meaning in the art and refers to a substantially spherical molecule generally comprising a fused network of five-membered and/or six-membered aromatic rings. For example, C₆₀ is a fullerene which mimics the shape of a soccer ball. The term fullerene or fullerene species may also include molecules having a shape that is related to a spherical shape, such as an ellipsoid. It should be understood that the fullerene may comprise rings other than six-membered rings. In some embodiments, the fullerene may comprise seven-membered rings, or larger. Examples of specific fullerenes include, but are not limited to, C₃₆, C₅₀, C₆₀, C₇₀, C₇₂, C₇₆, C₈₄, C₉₄, other fullerenes containing up to 100 carbon atoms, or greater. In some cases, the fullerene species may be a dimer, a trimer, or the like.

In some cases, the fullerene species may have a diameter in the range of about 10 nm or less, about 5 nm or less, or about 1 nm or less. In some cases, the fullerene species may have a diameter in the range of about 4 Å to about 16 Å, about 6 Å to about 16 Å, about 6 Å to about 9 Å, or about 7 Å to about 9 Å. In a particular embodiment, the fullerene species has a diameter of about 7 Å (e.g., as in C₆₀).

In some cases, the fullerene species is an endohedral fullerene, that is, fullerene species which include atoms, ions, or other species positioned within the interior of the fullerene sphere. In some cases, the endohedral fullerene includes a metal species. In some cases, the fullerene species is a magnetized fullerene (e.g., an endohedral fullerene including a magnetic metal species).

The fullerene species may be selected to have a resonant frequency different from that of the porous material precursor, such that heating the porous material precursor may remove the embedded fullerene species and may generate the pores. In one embodiment, an implanted fullerene dimer with a resonant frequency different from the porous material precursor is used to heat pores through the surface of the porous material precursor. In some embodiments, the porous material precursor may be “grown” around magnetized fullerenes, which can then be removed efficiently to produce the porous material. Similarly, fullerenes may be used as a negative mask on a substrate for etching processes.

In some cases, a porous material precursor and a substrate precursor may be combined to produce a material consisting of the porous material formed on the substrate. In some cases, a porous material precursor may be employed to form the porous material directly on the substrate. Such methods may simplify fabrication by eliminating the step of removing a porous material from, for example, a growth substrate, to be arranged on a substrate for filtration.

In another set of embodiments, a method for fabricating the porous material may involve the use of graphene oxide as a starting material. For example, graphene oxide may be reduced to produce a graphene material containing a plurality of defects or pores, generated due to the release of carbon atoms in the form of CO and CO₂. Accordingly, the method may involve exposure of a graphene oxide material to a set of reducing conditions to produce a porous graphene material comprising a plurality of pores. The set of reducing conditions may involve heating/annealing the graphene oxide material, treating the graphene oxide material with a chemical reagent, or the like. In some cases, the graphene oxide material may be treated with hydrazine, a sodium ammonia solution, sodium hydride, hydrogen sulfide, NaBH₄, acids including, but not limited to, H₂SO₄, dimethylhydrazine, hydroquinone, aluminum powder, and the like. Optionally, the pores may be substituted with various functional groups, including hydrophobic and/or hydrophilic groups, along the pore sidewalls and/or at or near the pore edges. Those of ordinary skill in the art would be capable of selecting the appropriate set of conditions for reduction of graphene oxides, including temperature of annealing, time of annealing, chemical treatment to generate functional groups, and the like, in order to produce a porous graphene material having pores of a desired size and functionalization. The resulting porous graphene material may then be arranged as a filtration material.

In one set of embodiments, the membrane surface, pore edges (e.g., pore entrance), and or pore sidewalls may be fabricated to have a suitable level of hydrophobicity in order to reduce fouling, mineral crystallization or organic buildup, and/or to promote fluid flow through the pores. In some cases, a gradient of hydrophobic properties may be established along the membrane surface, pore edges, and or pore sidewalls.

In another set of embodiments, ion bombardment may be employed to create pores of varying size distribution with a material, such as metal-containing material or a nanostructured carbon material. Those of ordinary skill in the art would be capable of selecting the appropriate process parameters, including cooling rate, re-warming temperature, and electron beam intensity, suitable for use in creating a particular desired porous material.

Any of the methods described herein may be performed as a continuous process or as a discontinuous process (e.g., batch process).

Porous materials, including porous graphene materials, as described herein may be configured and arranged in a filtration apparatus for the filtration of various solutions. In some embodiments, the porous material may be associated with one or more support materials or substrates. For example, the support material may serve to minimize or prevent tears or other defects in the porous material. The support material may also enhance the mechanical strength of the porous material. In some embodiments, the support material may be a polymeric material. In some embodiments, the support material may be a porous polymeric material. Examples of such support materials include, but are not limited to, polysulfone, copper, polytetrafluoroethylene (PFTE), poly(methyl methacrylate) (PMMA), synthetic fibers including but not limited to Kevlar®, aluminum including, but not limited to anodized aluminum, and the like. In some embodiments, the average density of the support material may be determined by the mechanical properties of the porous material (e.g., graphene), as relatively stronger porous materials may be capable of bearing the load for more support materials.

In one set of embodiments, the porous material may be assembled into a spiral-wound membrane. For example, the porous material may be formed or placed in contact with one or more support materials made from porous materials such as polysulfone. The layered assembly may then be rolled into a spiral and assembled into a membrane element with end caps. The resulting spiral-wound membrane can be inserted in a conventional NF/UF/reverse osmosis water production skid, or employed in alternative applications.

In some embodiments, arranging the porous materials in combination with one or more support materials may improve the mechanical stability of the porous material under applied pressure. For example, nanoporous graphene monolayers pinned every 40-160 Å on a porous polysulfone layer may withstand pressures upward of 500 MPa without ripping.

Without wishing to be bound by theory, the porous materials described herein may be capable of excluding various species from its pores by one or more physical exclusion mechanisms. In some cases, the mechanism may be size exclusion, i.e., pores having an effective diameter that is narrower than that of the species may physically force the species to remain on the feed side of the porous material. Typically, the effective diameter of the species may correspond to, in the case of ions, the solvated diameter of the species, and, in the case of uncharged solutes, the van der Waals radius of the species. In some cases, chemical interactions between the species and functional groups present within and/or at or near the entrance of the pores, the relative hydrophobicity or hydrophilicity of the functional groups, and/or the partial charge of the functional groups, may contribute at least in part to the energetic barrier that may prevents various species from permeating the porous material. In some cases, the Donnan exclusion principle may also enhance exclusion of charged species from the pores by repelling the species away from any fixed charge on the surface of the porous material. Factors such as these (e.g., size exclusion and electrostatic repulsion) may contribute towards a higher energy barrier for passage of various species, than for passage of water molecules.

Embodiments described herein may be useful in a wide range of applications. In some cases, the porous materials may be useful in high-efficiency reverse osmosis desalination, including desalination operations for activities such as municipal water production, semiconductor manufacturing, pharmaceuticals, oil and gas, and the like. The high permeability of the porous materials described herein can allow for a 20-70% reduction in driving pressure for a given water output, or alternatively a 60-500% increase in water output for the same driving pressure.

In some cases, the porous materials may be useful in nanofiltration and ultrafiltration applications. For example, spiral-wound elements that contain nanoporous graphene with pores in the 100 nm range as an active layer may be used as UF/NF membranes in existing and plants that rely on water purification, including desalination operations, municipal water plants, food and beverage production, and so forth. The high permeability of these membranes would allow for an important reduction in driving pressure for a given water output, or alternatively an important increase in water output for the same driving pressure.

In some embodiments, ultrafiltration methods may be improved by employing the relatively thin porous materials described herein, as the permeability of a membrane is inversely proportional to its thickness.

In some embodiments, the porous material may be useful in water pretreatment.

In some embodiments, the porous material may be used in forward osmosis desalination, a method that relies at least in part on a draw solution to separate fresh water from saltwater across a semipermeable membrane. Because forward osmosis does not rely on high applied hydraulic pressures, this method can employ relatively thin membranes with a higher density of pores than would be permissible for reverse osmosis.

In some embodiments, the porous material may be useful in the separation of molecules with similar boiling points and chemical properties but dissimilar sizes. For example, hydrocarbons with similar boiling points (e.g. olefin/paraffin) may be separated more efficiently and more economically using porous material described herein. Additionally, the porous materials may allow for fabrication of more compact and more stable filtration system that can be operated for long periods of time.

In some cases, the porous material may be useful in the separation of water and alcohol. While current methods such as fractional distillation can purify ethanol to ˜97%, porous materials described herein may allow for high-performance separation of water from alcohol with no theoretical limit on the purity of products. The separation process may occur more rapidly and more energy-efficiently than with other materials, such as zeolite-based molecular sieves.

In some cases, the porous materials may be useful in the isolation of DNA from a liquid solution in genome sequencing applications.

In some cases, the porous materials may be useful in various applications involving military reverse osmosis application. For example, surface and subsurface naval ships are often constrained by space and manpower for maintenance. However, the use of longer-life, high-flux porous materials can enable fewer filter replacements as well as production of the required fresh and deionized water volume with a smaller spatial footprint. Similarly, the porous material can provide various self-sustaining technologies for long time periods, suitable for use on, for example, army bases. The stability of carbon-based thin film porous materials may be attractive for reduced maintenance and replacement concerns. Further, these high flux membranes can reduce the burden of brine disposal for inland applications.

In another set of embodiments, the porous material may be useful in the prevention of mineral scaling. For example, nanoporous materials can be tailored to reject species responsible for scaling, including calcium, barium, strontium, sulfate, and carbonate ions.

In another set of embodiments, the porous materials may be suitable for use in high temperature filtration applications due to enhanced stability of the materials at high temperatures. For example, graphene may be a stable solid at high temperatures.

The porous materials may be useful in other applications such as magnesium extraction, rock-salt production, algae harvesting, backflow water treatment in hydraulic fracturing, enhanced gas or oil recovery, ultrapure water production.

Having thus described several aspects of some embodiments of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

### EXAMPLES

### Example 1

Because flux across a membrane scales inversely with the membrane's thickness, new types of ultrathin membranes offer the promise of greatly increased water permeability. Graphene, which consists of a 2D sheet of sp²-bonded carbon atoms in a hexagonal honeycomb lattice, is a candidate for use as a thin membrane. Graphene can be manufactured on a large scale with roll-to-roll production of 30 inch graphene films already available. Potential advantages of graphene over existing reverse osmosis membranes include negligible thickness (one or several atomic layers) and high mechanical strength, which may enable faster water transport, low pressure requirements, and a wider range of operating conditions than previously possible. Nanopores can be introduced into graphene's structure with the unsaturated carbon atoms at the pore edge passivated by chemical functional groups.

Experimental studies have explored a wide variety of methods for introducing nanopores in graphene, including electron beam exposure, diblock copolymer templating, helium ion beam drilling, and chemical etching. Although existing studies have found potential applications of nanoporous graphene in fields such as DNA sequencing and gas separation, the potential role of this material for water desalination remains largely unexplored.

In this example, computational results are described indicating that single-layer graphene can effectively separate salt from water for use in desalination systems. Using classical molecular dynamics simulations, desalination dynamics are shown to change with pore size, pore chemistry, and applied hydrostatic pressure. The calculations demonstrate that water can flow across a graphene membrane at rates in range of 10-100 L/cm²/day/MPa while still rejecting salt ions, which is 2 to 3 orders of magnitude higher than diffusive reverse osmosis membranes.

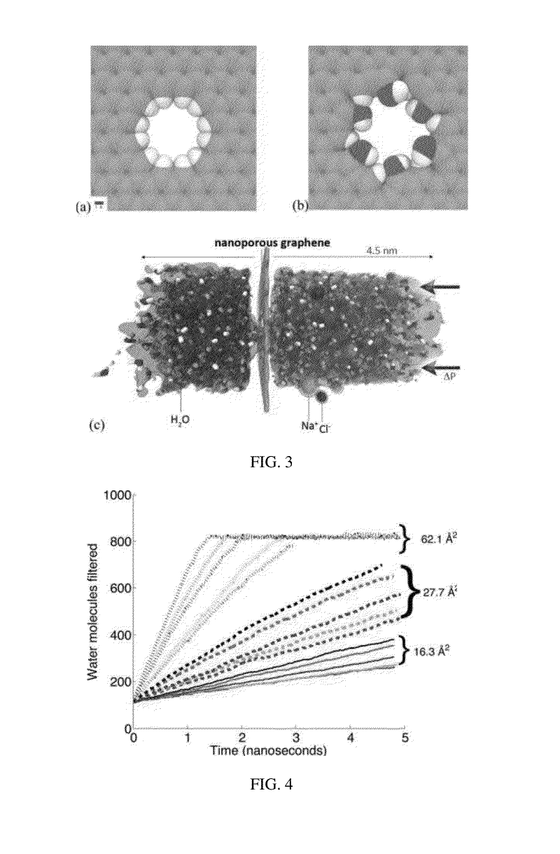

Computational Methods: The pore sizes were varied from 1.5 to 62 Å², and pores passivated with both commonly occurring hydroxyl groups (which are hydrophilic in nature) and hydrogen atoms (which are hydrophobic) were examined in order to examine the effect of pore chemistry on desalination dynamics. (FIG. 3) Water was modeled using the TIP4P potential, while interactions for all other atomic species were modeled using Lennard-Jones (LJ) and Coulombic terms. The parameters employed for each interaction type are summarized below.

System Composition: A two-dimensional, periodic sheet of porous pure graphene was modeled by starting with a perfect unit cell of 30×30 Å and removing the carbon atoms contained within circles of varying diameters centered at the unit cell center. A layer of 113 water molecules was initially placed on the permeate side of the membrane in order to accurately model the flow dynamics. Saltwater was generated using the Solvate and Ionize tools in the VMD software. The system was simulated using the LAMMPS package (Plimpton, S. LAMMPS-large-scale atomic/molecular massively parallel simulator; Sandia National Laboratories, 2007). The initial conformation of the OH groups was obtained by performing a static energy minimization. Consistent with behavior of hydroxyl groups in phenol and related molecules, the O atoms preferentially sat in the plane of the graphene membrane, while the H atoms placed themselves in or out of plane depending on their electrostatic interactions with neighboring OH groups.

Parameters. Na⁺ and Cl⁻ ions and carbon-water interactions were modeled using the LJ parameters derived by Joung et al. (Joung, I. The Journal of Physical Chemistry B 2008) and Beu et al. (Joung, I. The Journal of Physical Chemistry B 2008) respectively. In simulations where hydroxyl groups were applied to the pore edges, the hydroxyl groups were described by the parameterization of phenol by Mooney et al. (Mooney, D.; Mueller-Plathe, F.; Kremer, K. Chem Phys Lett 1998, 294, 135-142), which includes harmonic bond potentials for the C—O and O—H bonds, harmonic angles for the C—C—O and C—O—H angles, and harmonic dihedral potentials for the C—C—C—O and C—C—O—H dihedral angles, as well as Lennard-Jones (LJ) parameters for the interactions between each hydroxyl group and nearby atoms. A similar parameterization drawing from Muller-Plathe et al. (Müller-Plathe, F. Macromolecules 1996, 29, 4782-4791) was employed for hydrogen functional groups. The parameters are summarized in Table 1.

TABLE 1
LJ and charge parameters.

| | C | | | | | | | | | |
|---|---|---|---|---|---|---|---|---|---|---|
| Element | (sp2) | C_{COH} | H_{COH} | O_{COH} | C_{CH} | H_{CH} | H_{w} | O_{w} | Cl⁻ | Na⁺ |
| ε | 0.0859 | 0.0703 | 0 | 0.155 | 0.046 | 0.0301 | 0 | 0.16275 | 0.0117 | 0.1684 |
| (kcal/mol) | | | | | | | | | | |
| σ (Å) | 3.3997 | 3.55 | 0 | 3.07 | 2.985 | 2.42 | 0 | 3.16435 | 5.1645 | 2.2589 |
| q (e) | 0 | 0.2 | 0.44 | −0.64 | −0.115 | 0.115 | 0.5242 | −1.0484 | −1 | 1 |

The partial charges on membrane atoms were also held fixed during the calculations. Carbon atoms away from the pore edge were assigned neutral charge, while the partial charges on the functional groups and the neighboring carbon atoms were taken from the parameterization for the relevant functional group. Keeping partial charges fixed did not allow for electric charge rearrangement and polarization effects in the membrane, but the preferred electronegativities of the oxygen and hydrogen atoms passivating the pores ensured that the dominant Coulombic effects were captured accurately. The inter-atomic LJ parameters between species i and j were calculated using Lorentz-Berthelot mixing rules.

Post-Processing: The resulting atomic trajectories were subsequently analyzed using the LAMMPS Pizza.py toolkit, as well as the H-Bonds, Radial Distribution Function and Volmap tools in VMD.

The TIP4P model allowed for water polarization arising at the intermolecular level via orientational rearrangement, while intramolecular contributions to water polarizability (due to bond and angle deformations as well as changes in electronic structure) were not explicitly included. These additional components of polarizability are known to affect several water properties including dimer stability, but it was observed that the orientational contribution dominated the physics of the system. To quantitatively assess this point, an auxiliary set of simulations was performed that allowed for enhanced water polarizability within individual water molecules by allowing for flexible bonds and angles (i.e., geometric polarizability) using the SPC/F (flexible) force field. This component of polarizability was in addition to the orientational component, which was already captured in the TIP4P model. The results of these flexible water simulations, discussed in more detail below, indicated that the rigid TIP4P model provided similar dynamics at lower computational cost.

All simulations were performed using the LAMMPS package. Hydrogenated pores were obtained by passivating each carbon at the pore edge with a hydrogen atom. For hydroxylated pores, the unsaturated carbons along the pore edge were alternatively bonded with H— and OH— groups. Although this pore chemistry also contains hydrogen groups, the calculations indicate these pores are more thermodynamically stable with this alternating pattern because it can prevent steric interactions between neighboring OH— groups. Furthermore, the OH— groups primarily govern the water-pore interactions because they extend further from the pore edge. The size of each pore was measured by plotting atoms as van der Waals spheres and calculating the amount of contiguous area not obstructed by any atomic representations. Pore diameters were obtained from the open pore area measurements by the straightforward formula d=2√(A/π), which resulted in nominally smaller diameters than the center-to-center measurements employed in other works. In order to decouple the transport behavior of saltwater through the membrane from mechanical deformation phenomena, the carbon atoms in the membrane were held fixed during the simulations. A nonpolarizable model was employed for salt ions. Although this approximation impacted the distribution of ions in the vicinity of interfaces, this was expected to have a negligible effect on the transport properties examined since the passage (or rejection) of salt ions is primarily determined by the high applied pressure and not by their equilibrium position with respect to the membrane. To the extent that polarization of the ions modified the ion dynamics at the water/membrane interface, the polarizability was expected to result in an enhanced salt rejection, as Cl-ions become more strongly repelled by the graphene interface.

The saltwater in the system contained 16 Na-ions and 16 Cl-ions solvated by 825 water molecules, corresponding to a salt concentration of 72 g/L. A higher salinity than seawater (˜35 g/L) was chosen in order to increase the occurrence of ion-pore interactions and obtain more precise results for a given system size and simulation time. The initial system consisted of a box measuring 75 Å in the z-direction and periodic x−y plane with a unit cell cross-section of 30×30 Å. The graphene membrane was fixed at z=60 Å, and a rigid piston was originally placed at z=0 and subsequently allowed to push the water toward the membrane at a prescribed external pressure. After initially subjecting the system to pressures ranging from 1 MPa all the way to 1500 MPa, the calculations were focused in the 100-200 MPa range in order to obtain well-converged statistics for the time scales involved in these MD calculations. Although these pressure values are significantly higher than what is typical for desalination (a few MPa), the fact that the time scales for flow scaled linearly with applied pressure strongly suggested that the results would also hold valid at low pressures.

The NVT ensemble was used with a Nosé-Hoover thermostat at 300 K with an initial Gaussian velocity distribution consistent with this temperature. After an equilibration time of 100 ps during which the external piston pressure was kept at P=0, runs were carried out on the order of 5-10 ns with a time step of 1 fs. The properties calculated (detailed below) were obtained by averaging over 5 separate runs starting from different sets of initial conditions for each configuration to ensure that the quantities were converged.

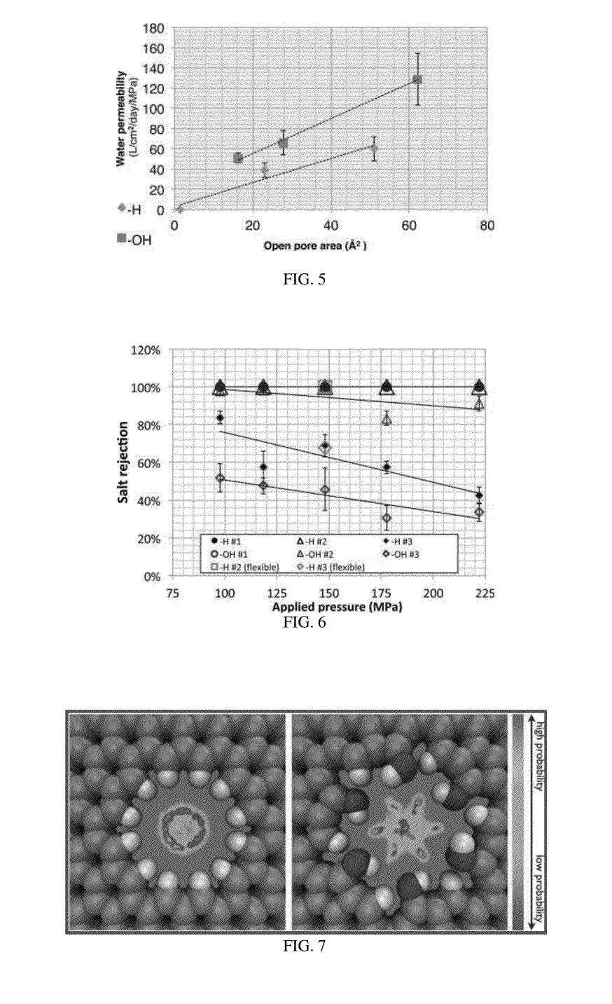

Water Permeability. The water flow across three different hydroxylated pores as a function of time is shown in FIG. 2. The flow profiles showed that the flow rate of water was constant in time and increased with pore size and applied pressure. For narrow enough pores, water molecules were unable to pass and no water permeation was observed during the entire trajectory. Conversely, when the water flow was fast enough, the curve eventually reached a saturation point indicating that the entire reservoir of water molecules on the feed side had become depleted before the end of the simulation. Each trajectory began with a linear regime in which water flowed at a constant rate: the behavior of the system indicated that the effects of the finite size of the periodic simulation box, including the relative increase in feed salinity as water was gradually filtered through the membrane, were negligible in this regime. The slope of each flow curve in FIG. 4 corresponds to the flow rate per unit of time, which was found to be proportional to applied pressure. Thus, the dynamic quantities derived here could be extrapolated down to the operating conditions more typical of reverse osmosis plants, (ΔP≈5 MPa) by defining a water permeability normalized per unit of applied pressure. Assuming a relatively conservative membrane porosity of 10%, the effective water permeability achieved in each system was estimated. (FIG. 5) The water permeability, expressed in liters of output per square centimeter of membrane per day and per unit of applied pressure, ranged from zero (for the narrowest hydrogenated pore) to 129 L/cm2/day/MPa in the case of the largest hydroxylated pore simulated. The permeability scaled linearly with pore area, as expected from the Hagen-Poiseuille equation in classical fluid dynamics for flow across a cylindrical pore. (FIG. 5)

On the other hand, the effect of pore chemistry had no clear analog in macroscopic fluid dynamics. For a given pore size, water permeability is significantly enhanced by hydroxylation: the permeability across the ˜25 Å² pores (and the ˜50 Å² pores) was larger by 69% (and 115%, respectively) compared with the hydrogenated case. This behavior was in part due to the fact that hydrophilic functional groups increased the water flux by allowing for a greater number of hydrogen-bonding configurations inside the pore.

Salt Rejection. While pores should typically exceed a critical size in order to permeate water molecules, they should also be narrower than a maximum diameter in order to effectively hinder the passage of salt ions. In this example, data for permeate salinity suggested that this maximum diameter is around 5.5 Å, that is, that the majority of salt ions approaching the pore entrance were able to pass through the membrane beyond this diameter.

The calculated salt rejection for each nanoporous membrane is shown in FIG. 6. Salt rejection was calculated from the salinity of the permeate solution at t=t1/2 (defined as the time when half the water has flowed to the permeate side) relative to the initial salinity of the feed for the range of pore systems. For a perfectly rejecting membrane R=100%, the permeate salinity was zero, while a membrane with no salt rejection (R=0%) would yield the same salinity in the permeate as in the initial feed. FIG. 6 shows that salt rejection was close to 100% for the smallest hydrogenated and hydroxylated pore as well as for the medium hydrogenated pore. For the remaining pores, the salt selectivity decreased both with pore size and applied pressure, reaching a minimum of 33% for the largest OH-functionalized pore at 222 MPa.

While salt rejection decrease with increasing pore size was expected from a size exclusion argument, salt rejection was also affect by applied pressure. In particular, the salt rejection of a given pore decreased at higher applied pressures, the opposite of what is observed in most diffusive reverse osmosis membranes. Without wishing to be bound by theory, this difference in behavior may be in part due to the large effective volume of ions in solution, which can cause them to respond more sensitively to pressure increases than water molecules. This is in contrast with the kinetics of ion passage across diffusive reverse osmosis membranes, in which the governing driving force for salt passage is osmotic pressure and where water flux increases faster than salt flux with rising pressure.

By comparing the salt rejection predicted using the flexible SPC/F water model with the main results presented here using the TIP4P water model, it was inferred that intramolecular vibrations and polarizability play a negligible role in the dynamics of saltwater transport in this example. Indeed, a set of five SPC/F calculations performed at 148 MPa for the largest and second largest hydrogenated pores yielded salt rejection values within 1% of the TIP4P results. (FIG. 6) This suggested that molecular polarizability, while important for predicting other properties in water, may not be a leading-order effect in the desalination performance studied in this example.

The results indicate that pore chemistry also has a notable effect on salt rejection. For a given pore size and applied pressure, the salt rejection was lower for hydroxylated pores. This effect was in part attributed to the fact that OH functional groups can hydrogen-bond with salt ions much like water molecules, which can result in a lower free energy barrier to ionic passage.

Water Structure in the Pore Vicinity. The organization of water molecules in the vicinity of the pores can often play a dominant role in both the water permeability and the salt rejection of a nanoporous graphene membrane. The water structure may in turn determined both by size effects (i.e., pore size) and chemical effects (i.e., pore functionalization). In order to further understand why hydroxylated pores exhibit higher water permeability and why hydrogenated pores are more effective at rejection salt, several properties that indicate how water flows across each pore have been investigated.

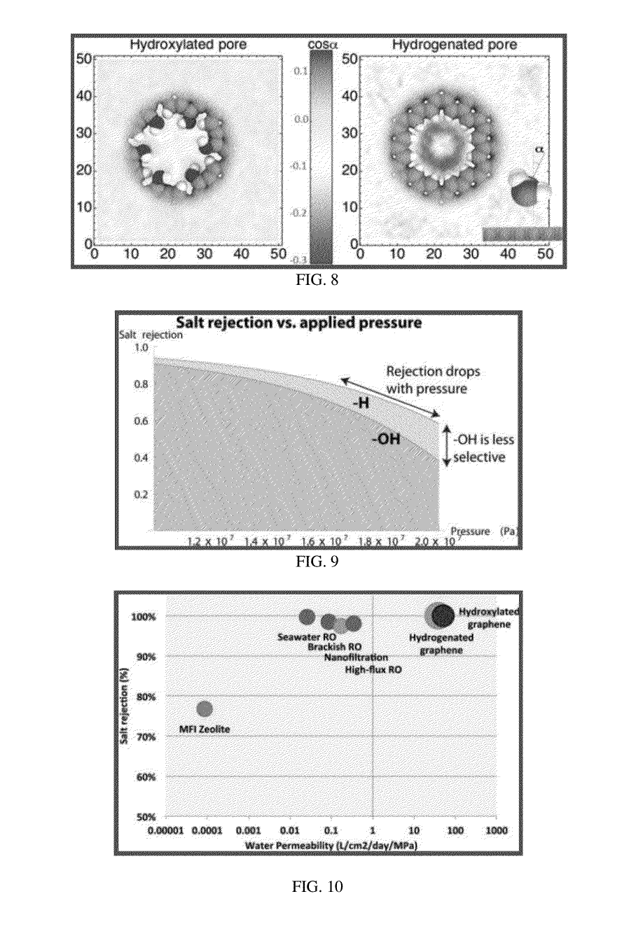

In principle, the higher flow rates across hydroxylated pores could arise from either a broadening of the cross-sectional area available to water molecules, and/or from faster passage of each water molecule. To identify which effect is dominant here, density maps for oxygen atoms of water molecules inside H- and OH-functionalized pores have been calculated. (FIG. 7) Although the shapes of the density surfaces differ to reflect the radial and 6-fold symmetry of the H— and —OH functionalized pore, respectively, the figure revealed that the total cross-sectional area available for water passage across the H-functionalized pore was only smaller by about 25%. However, to explain the 69-113% drop in water permeability found in hydrogenated pores, another factor may be at play, such as an entropic effect. To illustrate this, the angular distribution function of water molecules in the vicinity of a graphene nanopore was plotted. As shown in FIG. 8, water is more ordered in the vicinity of a hydrogenated pore. This higher level of ordering is consistent with the fact that hydrogen passivation is hydrophobic and hence can restrict the number of hydrogen-bonding configurations available to water molecules traversing the membrane. In contrast, OH— groups can hydrogen-bond with water and can offer a relatively smoother entropic landscape for water molecules to traverse, thus allowing for faster overall water flow. The effect of pore chemistry on water structure can thus explain at least in part why hydroxylated pores have higher water permeability than hydrogenated pores.

Kinetic Behavior. The qualitative behavior of water desalination across a nanoporous graphene membrane, including the entropic effect of pore chemistry and the salt rejection drop at higher pressures, was reproduced with a simplified kinetic model involving a reduced number of variables. Assuming an Arrhenius model for both water and salt passage and neglecting finite size effects, the rates of water and salt passage respectively were approximated as

\dot{N}_{w}=A₀e^{-Ω}^{_{w}}^{P-(ΔE+TΔS)/kT}

\dot{N}ₛ=B₀e^{-Ω}^{ₛ}^{P-(ΔE+TΔS)/kT}

where A₀(T) and B₀(T) represent the attempt rates for water and salt passage, respectively. These attempt rates may be treated as constant for a given pore size, chemistry, applied pressure, temperature, and salt concentration. Ωᵢ denotes the effective volume of a molecule of species i; this effective volume multiplied by the applied pressure acts as a driving force for species passage. The (ΔE+TΔS) terms represent the free energy barrier for species i associated with traversing the pore. For nanometer-scale pores, this free energy barrier was expected to be a large quantity, and the MD results described above indicate that it can be expected to be larger for a hydrophobic pore compared to a hydrophilic one, since the entropic barrier for entering the pore is higher. In this kinetic model, the steady-state permeate salinity is given by the ratio of the two permeation rates, \dot{N}s/\dot{N}w.

The larger volume of solvated ions relative to water molecules can explain at least in part the observed salt rejection drop at higher pressures: although salt and water permeation rates both increased linearly with pressure, the salt had a larger effective volume. Accordingly, the salt flow rate increase was steeper than that of water and results in a lower overall salt rejection for increasing pressure. Representative values for the effective volumes (ω_{w}˜10⁻²⁸ m³, Ωₛ˜10⁻²⁷ m³, T=300) and the attempt rates expected from kinetic theory (A₀˜10¹¹ s⁻¹, B₀˜10¹⁰ s⁻¹) were taken. To test the hypothesis that an entropic barrier can account for the contrasting properties of hydrophilic versus hydrophobic pores, a larger value of ΔS was assigned to the hydrogenated pore than to the hydroxylated pore (ΔS=4.5 and 5.5 k, respectively). For simplicity, the entropic barrier for salt passage was assumed to be higher than for water passage by a factor of 10%. The choice of an energy barrier ΔE was arbitrary since it did not appear in the expression for salt rejection. Alternatively, a refinement to this model would be to specify two different values of ΔE for salt ions across OH— and H— functionalized pores, but the results below show that the present level of detail may be sufficient to qualitatively reproduce the main observed trends.

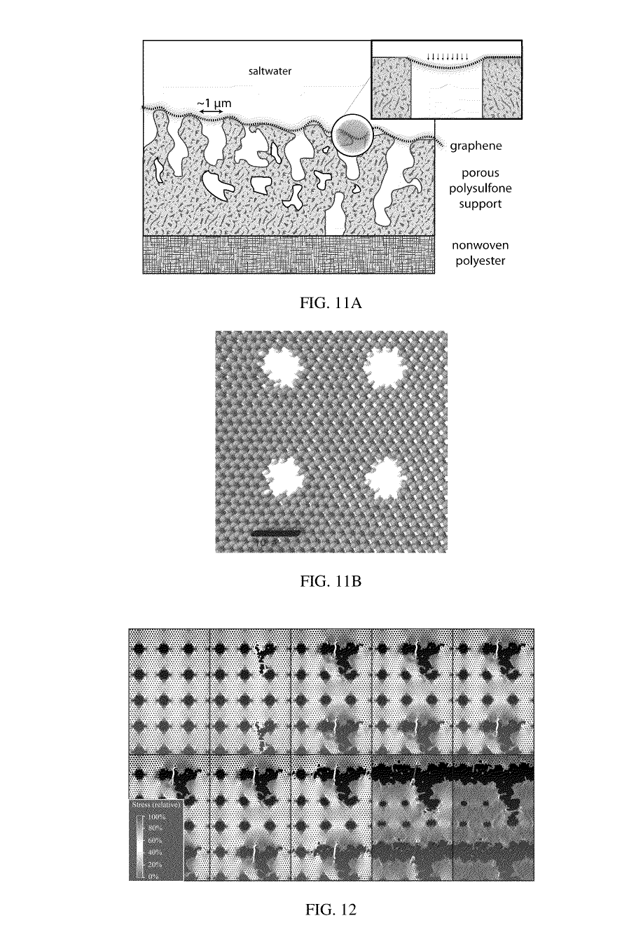

FIG. 9 shows a graph of steady-state salt rejection predicted by this model. The plots indicate that the simple kinetic model proposed here qualitatively replicates the trends observed in the MD trajectories: (a) salt rejection is a decreasing function of applied pressure; (b) salt rejection is higher for a hydrogenated pore. Overall, the results indicate that graphene could act as a high-permeability desalination membrane. For illustrative purposes, the theoretical performance of graphene pore configurations examined here is plotted along with the experimental performance of reverse osmosis in FIG. 10. Among the pore configurations that exhibited both full salt rejection and waterpassage (23.1 Å² hydrogenated pore and 16.3 Å² hydroxylated pore), the water permeability ranged from 39 to 66 L per cm²·day·MPa. In contrast, experimentally observed permeabilities for reverse osmosis typically are around a few Cl per cm²·day·MPa (and values predicted from MD simulations lie in this range as well).

### Example 2

The following example examines the ability of graphene materials to withstand the mechanical requirements of reverse osmosis. The resistance of freestanding NPGs to applied hydraulic pressure was quantified by investigating the maximum water pressure that a patch of NPG can withstand before the C—C bonds in the pore vicinity might begin to dissociate. This critical pressure may depend not only on the size and spacing of the nanopores, but also on the diameter of the pores and/or cavities in the supporting structure. Table 2 lists the mechanical properties of graphene used in this example.

RO membranes can extract fresh water from pressurized saltwater. In conventional thin-film composite (TFC) membranes, an active layer that is typically composed of polyamide extends about 100-200 nm in thickness, and may be supported by a polysulfone substrate that is more porous and thicker than the active layer, with cavities around 0.1-0.5 μm and an overall layer thickness around ˜100 μm. A statistical analysis of cavity sizes in polysulfone suggested an average cavity radius of 0.2 μm, with few or no pores larger than 2.5 μm.

FIG. 11A shows a schematic representation of the arrangement of a nanoporous graphene (NPG) membrane, which is supported by a substrate with cavities on the lengthscale of 0.2 μm. The inset shows the predicted mechanical loading on a patch of graphene due to applied pressure in a reverse osmosis system. FIG. 11B shows the molecular visualization of a hydrogenated NPG, with pores having a radius of 0.5 nm and separated by approximately 2.4 nm. Scale bar indicates 10 Å.

The ability of NPGs to withstand hydraulic pressure often depends on the size of the freestanding patches of membrane suspended over cavities in the substrate, as well as on the stress distribution within the nanoporous membrane. FIG. 12 shows the stress distribution in an NPG sheet during failure (22% strain, 75.3 GPa), with stress at each atom is represented by its color, with darker regions corresponding to the areas of highest stress (see color bar). The stress near the pores is about 1.5 higher than the stress away from the pores.

The fracture mechanics of a material like NPG may be viewed as a multi-scale problem. Membrane sheets in commercial RO operations typically extend about 40 m², while the patches of suspended NPG would measure about 100 nm Finally, it may be desirable for the graphene pores to have a maximum pore size (e.g., diameter) of 1.0 nm in order to effectively reject monovalent salt ions. The system of interest thus exhibits three different length scales. The geometrical deflection and overall mechanical response of NPG can be described by continuum mechanics because the typical length scale for the membrane patch of interest contains >100,000 carbon atoms. Macroscopic properties such as the elastic modulus and in-plane Poisson's ratio dominate the mechanical behavior of NPG at this length scale. In contrast, the pores in NPG play an essential role at the nanometer scale. The overall mechanical response of an NPG membrane under applied normal pressure was determined, followed by quantification of the extent of stress concentration. The mechanism for material failure at the level of individual nanopores using Molecular Dynamics (MD) simulations was also determined Finally, it was demonstrated that the atomistic results were consistent with continuum stress concentration theory.

Macroscopic stress distribution. The macroscopic stress distribution in the membrane was readily predicted from continuum mechanics by treating NPG as a homogeneous material at the lengthscale of the freestanding patch. Assuming that the membrane was clamped at the cavity edges and that no residual stress existed prior to loading, the transverse stress τ_{T} and radial stress τ_{R} in a circular membrane subjected to a pressure difference equal:

$${σ}_{T} = {σ}_{R} = \frac{2}{3} {( \frac{{w}_{0}}{{R}_{M}} )}^{2} \frac{{E}_{M}}{{c}_{0} - {c}_{1} {v}_{M} - {C}_{2} {v}_{M}^{2}}$$

where E_{M} and v_{M} are the Young's modulus and Poisson's ratio of the membrane and R_{M} is the radius of the suspended membrane patch. The radial and tangential components of the stress tensor are equal by virtue of the boundary conditions of the system. The constants c₀, c₁ and c₂ are ordinarily taken to equal 1, 1 and 0 respectively (which yields Cabrera's equation), but more accurate finite-element analysis results have found that the mechanics are captured most accurately for c₀=1.026, c₁=0.793, c₂=0.233. These numerical values were used for increased accuracy.

The maximum deflection w₀ increases with applied pressure according to:

$$Δ p = \frac{4 {w}_{0} {d}_{M}}{{R}_{M}^{2}} {σ}_{M} \\ = \frac{4 {w}_{θ} {d}_{M}}{{R}_{M}^{2}} ( \frac{2}{3} {( \frac{{w}_{0}}{{R}_{M}} )}^{2} \frac{{E}_{M}}{{c}_{0} - {c}_{1} {v}_{M} - {c}_{2} {v}_{M}^{2}} )$$

where d_{M} is the thickness of the membrane. Taking the elastic properties of graphene from Lee, C, X Wei, J W Kysar, and J Hone. 2008. “Measurement of the Elastic Properties and Intrinsic Strength of Monolayer Graphene.” Science 321 (5887): 385-88, the predicted average stress in an NPG patch as a function of applied pressure for a circular suspended patch of radius R_{M}=100 nm was computed. The membrane stress increased monotonically with applied pressure, and the values of stress were found to be significantly greater than the values of applied pressure. The reason for this may be analogous to the reason why the hoop stress is much larger than the internal pressure in a thin walled spherical vessel. For a patch diameter of 0.1 μm and ΔP=5 MPa (which is typical of seawater RO operations), the macroscopic membrane stress is about 200 MPa. However, continuum mechanics cannot predict the actual stress at which an NPG will fail. To this end, molecular dynamics simulations were employed.

Molecular dynamics simulations. A set of Molecular Dynamics (MD) simulations aimed at investigating nanoporous graphene failure at the atomic scale was employed. Following the methodology described in Min, K, and N. R. Alum, “Mechanical Properties of Graphene Under Shear Deformation,” Applied Physics Letters 2011, 98 (1), a stress-strain test was performed by enforcing a constant engineering strain rate of 0.0005 per picosecond after minimizing and equilibrating the NPG system. The strain was equibiaxial (εₓₓ=ε_{yy}), and the strain increments were applied every 10,000 timesteps. A short time step of 0.1 femtosecond was chosen in order to ensure energy conservation and to accurately model the behavior of NPG under stress. The thickness of graphene was taken to equal 3.4 Å. The simulations were performed using the LAMMPS MD code (version 7.8.2013). The simulation box contained 3 nanopores in each direction (for a total of 9 pores) and measured 73×74×20 Å (for a total of 2052 atoms), with periodic boundary conditions in the x and y (planar) directions and a fixed boundary in the z (normal) direction. The AIREBO potential was used with a cutoff factor of 3.0 and LJ and torsional terms included. Thermodynamic quantities were output every 10,000 steps. The global stress in the membrane and the local stress per atom were calculated by averaging the instantaneous values of the pressure tensor. These values were taken every 10 time steps during the entire second half of each strain increment, and the average was computed every 1 ps.

An identical set of simulations was also performed with nanoporous graphene submerged in water. The water molecules were modeled using the SPC potential and the fix/shake algorithm for O—H bonds and H—O—H angles, and the water-carbon interactions were modeled using Lennard-Jones parameters obtained by the Lorentz-Berthelot mixing rules. The z (normal) dimension of the simulation box was shrunk at a constant strain rate such that the volume of water in the system remained constant over time. The simulations of NPG submerged in water indicated that water can act to lower the fracture stress of NPG by up to 40% for a given nanopore radius and nanopore separation.

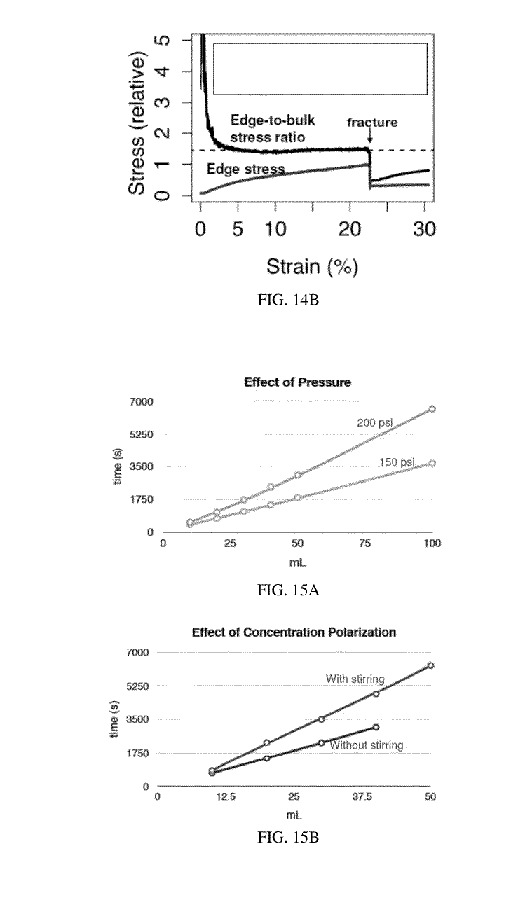

The results of the MD simulations are summarized in 4. FIG. 14A shows the global stress in an NPG membrane as a function of applied strain, while FIG. 14B shows the stress concentration factor (SCF), measured as the ratio of stresses in atoms at the pore edge vs. away from pores. The calculated Young's modulus of NPG is 786 GPa and its equibiaxial fracture stress is 75.3 GPa. Prior to yielding, the stress concentration factor is about 1.5. The data in FIG. 14A indicates that NPG fractures when the applied biaxial stress exceeds 75.3 GPa. Equivalent MD simulations carried out for pristine graphene yielded a fracture stress consistent with experimental data (˜120 GPa). The fracture stress of NPG was thus lower than for pristine graphene by a factor of ˜1.5. This phenomenon may be attributed at least in part to the presence of circular pores. From the vantage point of fracture mechanics, the pores in NPG can act as defects that distort the stress fields in the membrane and concentrate stress in their immediate vicinity. Thus, the pores can accelerate failure even when the macroscopic stress is below the fracture stress of the membrane. Further support for this hypothesis is shown by looking at the stress concentration factor (SCF) during the MD simulation. FIG. 14B indicates that stress near a pore edge is approximately 1.5 times larger than the stress away from the pore, which is consistent with the NPG membrane fails at ˜1.5 times lower applied stress than pristine graphene.

The characteristic radius for graphene pores was obtained by measuring the center-to-center distance between two diametrically opposed carbon atoms in a hydrogenated NPG sheet that exhibits full salt rejection. Measurement of this radius was based on the carbon atoms rather than the hydrogen functional groups at the pore edge because the latter are not bonded to each other, meaning that the relevant shape for stress concentration effects is the ring of carbon atoms that delimits the pore. This radius was found to be 5.1 Å.

The fracture strength of graphene is approximately 42 N/m (or σ_{y}=124 GPa after dividing by the effective thickness of the material, implying that the fracture stress of NPG may be approximately 124/1.46=82 GPa. This value is consistent with the fracture stress obtained from MD above (75.3 GPa). Moreover, macroscopic theory predicts an SCF of 1.46, given an average pore separation of 2.4 nm, which is also consistent the trend obtained in the MD simulations above. Thus, nanopores in an NPG membrane may behave similarly to cracks as far as their effect on fracture mechanics is concerned. In contrast, previous work has shown that 5-7 defects arising from grain boundaries in graphene may not follow the usual rules of continuum fracture mechanics (see Grantab, R, V B Shenoy, and R S Ruoff, “Anomalous Strength Characteristics of Tilt Grain Boundaries in Graphene,” Science 2010, 330 (6006): 946-48). Nanopores may behave more consistently with continuum fracture mechanics as they do not produce substantial pre-strain at equilibrium, unlike grain boundary samples in which pre-strain in specific bonds was identified as the main cause of early failure.

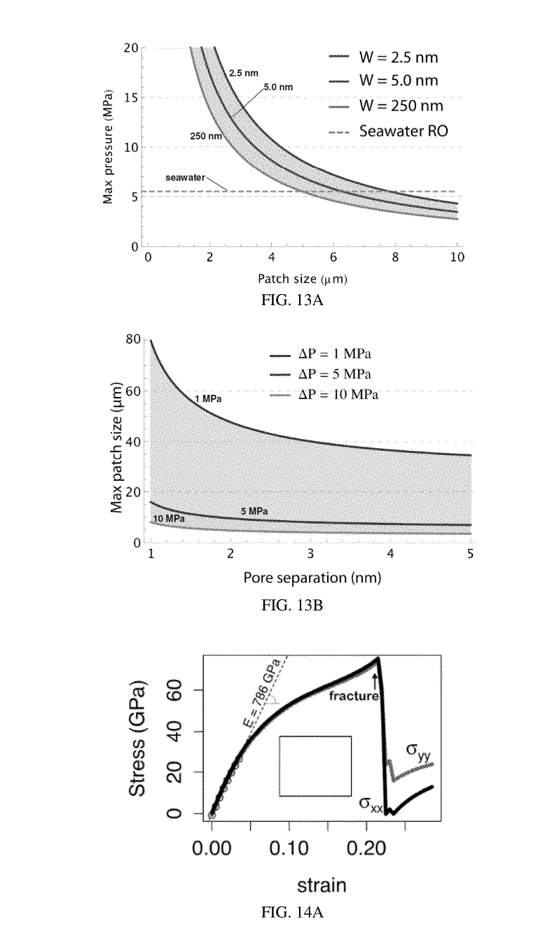

Maximum pressure in NPG. Using the results above, the maximum pressure that NPG could withstand as a function of cavity size and pore separation was calculated. FIG. 13A shows the maximum hydraulic pressure before membrane failure as a function of NPG patch size. An NPG membrane with pores spaced by 2.5 nm, 5.0 nm, and 250 nm could withstand pressures greater than those typically employed in seawater RO (dashed line) as long as all the cavities in the substrate are smaller than 5 μm, 6 μm or 8 μm, respectively. FIG. 13B shows the maximum patch size as a function of pore separation for a layer of NPG exposed to ΔP=1, 5 and 10 MPa. The maximum pressure for NPG decreases monotonically as a function of patch size, with patches in the range of 5-8 μm sufficient to weaken NPG below the typical pressure applied in seawater RO. The mechanical strength of NPG exhibited a slight dependence on the separation between nanopores, with lower pore densities allowing for larger patches (or higher pressures). (FIG. 13B) Beyond a pore separation of ˜4 μm, the maximum patch size consistent with a given pressure reached an asymptotic value.

While ultra-permeable membranes offer considerable promise for the future of clean water technology, the results presented in this example demonstrate that mechanical strength and choice of substrate are parameters to consider in the design of a functioning membrane. NPG was shown to be capable of withstanding the hydraulic pressures involved in membrane separation applications such as RO. While nanopores do act as stress concentrators and thus serve to reduce the maximum fracture stress of NPG compared with pristine graphene, the circular pores only increase the local stress by up to a factor of 2—and potentially less if the pores are densely distributed throughout the membrane. Notably, the presence of grain boundary defects in the membrane—a typical occurrence in CVD-grown graphene—may be unlikely to weaken the material further, since the fracture strength of graphene near grain boundaries is still as high as 71.7 GPa and potentially even higher. Additionally, mechanical integrity of the membrane depended at least in part on the size of the substrate cavities. For example, above ˜5 μm, the applied stress distributed across the membrane began to reach the intrinsic fracture stress of graphene and may in certain cases compromise the integrity of the membrane. When graphene is produced using chemical vapor deposition (CVD), its fracture stress grain remains as high as 103 GPa despite boundary defects.

This approach can be extended to other membrane materials, including graphitryne, 2d-polyphenylene, and other ultra-permeable membranes.

TABLE 2
Key mechanical properties of graphene used in this work,
based on Lee, C, X Wei, J W Kysar, and J Hone. 2008. “Measurement
of the Elastic Properties and Intrinsic Strength of Monolayer
Graphene.” Science 321 (5887): 385-88.

| Symbol | Quantity | Value | |
|---|---|---|---|
| E_{M} | Young's modulus | 790 | GPa |
| v_{M} | Poisson's ratio | 0.17 | |
| d_{M} | Membrane thickness | 3.4 | Å |

### Example 3

The following example describes the evaluation of filtration performance for commercial, fabricated, and surface modified filtration membranes.

In order to calibrate the filtration system to achieve consistent results, the permeability of several membranes was compared. 100 mL of deionized water and 0.3% by weight NaCl solution were inserted in the Sterlitech HP 4750 (Slide 10) cell in separate experiments and flux was measured for various commercial membranes and surface modified membranes at given parameters. FIG. 15A shows the effect of pressure on the flux across a GE Osmonics AG brackish water membrane. Lower pressure dramatically reduces the flow of permeate especially at higher recovery ratios. FIG. 15B shows the effect of the use of a magnetic stir bar to maintain well mixed conditions and prevent the accumulation of salt at the surface of the membrane. Further, the stir bar dramatically affects the salt rejection associated with the same membrane, holding all other parameters constant. With the stir bar, 91.85% salt rejection was observed. Without the stir bar, only 3.88% rejection was observed.

### Example 5

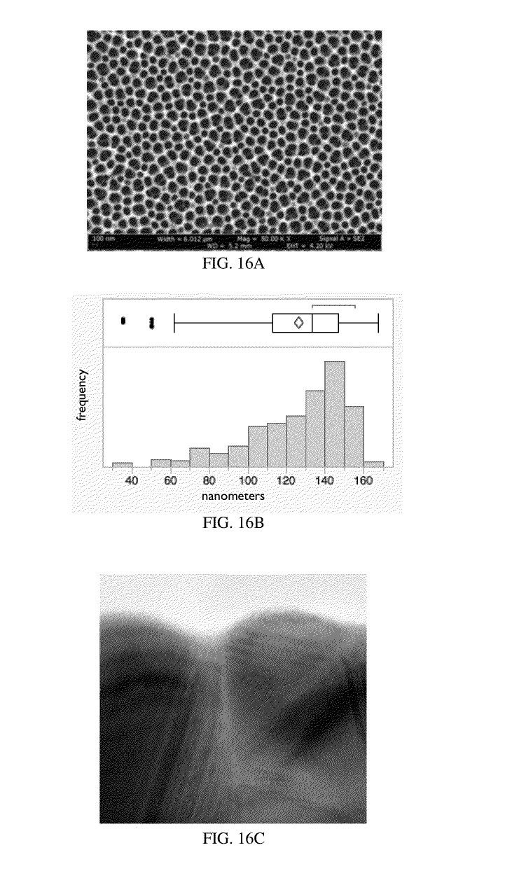

In this example, electron microscopy was used to measure and characterize membrane components. FIG. 16A shows an SEM image of an anodized aluminum membrane with assymetric pores. Using the open-source software ImageJ, the average pore size was measured to be 142 nm in diameter, with a pore size distribution shown in the histogram in FIG. 16B. As shown in FIG. 16C, high resolution transmission electron microscopy was used to view the crystal lattice of a gold nanoparticle. Using these instruments, silicon, alumina, graphene, and other porous materials can be evaluated at the sub-nanometer resolution.

### Example 5

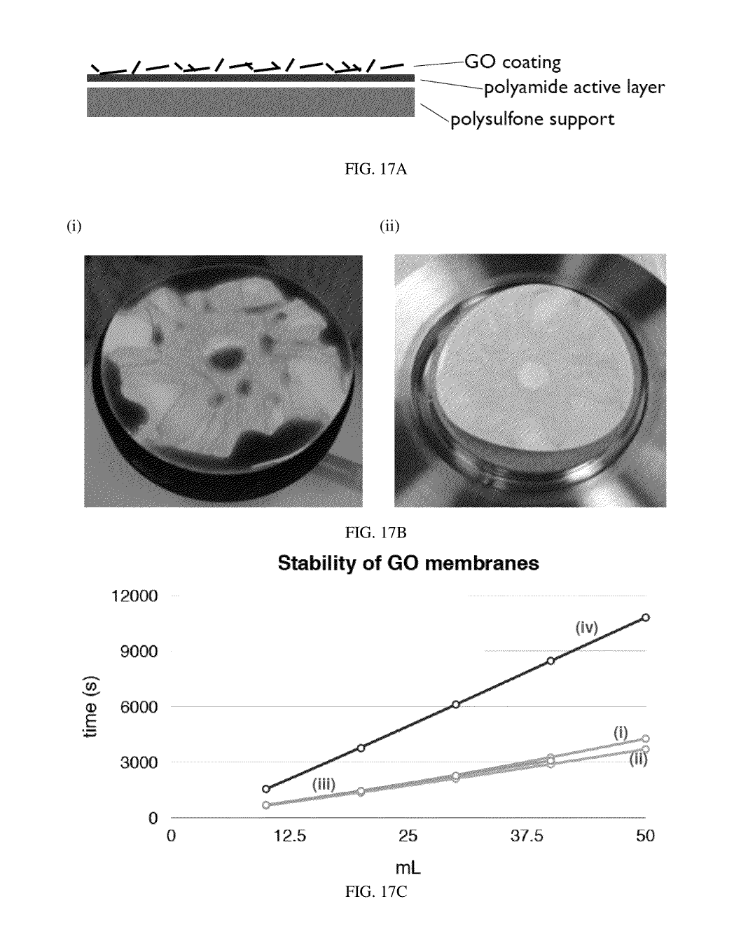

The following example describes the use of a surface modified-graphene oxide reverse osmosis membrane, schematically shown in FIG. 17A. Graphene oxide was dispersed in water (˜4 mg/mL) and sonicated for 15 minutes. It was then spin-coated onto a pre-conditioned GE Osmonics AG membrane at 640 RPM. (FIG. 17B(i)) Surface water was allowed to evaporate for 10 minutes in air before being returned to deionized water; the membrane did not fully dry out. FIG. 17B(ii) shows the membrane after its use in filtering 0.3% NaCl solution, again not dried, and returned to deionized water.

To determine the effect of this surface modification, four distinct states of the GE Osmonics AG membrane were evaluated: (i) pre-conditioned but unmodified, (ii) preconditioned and rested in DI water overnight, (iii) surface treated with GO solution, and (iv) surface treated with GO solution and rested in DI water overnight. (FIG. 17C) The first two states resulted in nearly identical flux, suggesting that the membrane does not degrade due to storage overnight. While the membrane that was surface-treated with GO solution exhibited the same flux as the untreated membrane, a substantial decrease in flux after being stored in DI water overnight. The notable effect of the GO after 12 hours of storage may be explained by rearrangement (flattening) of surface GO flakes, closure of defects in the GO surfaces.

### Example 6

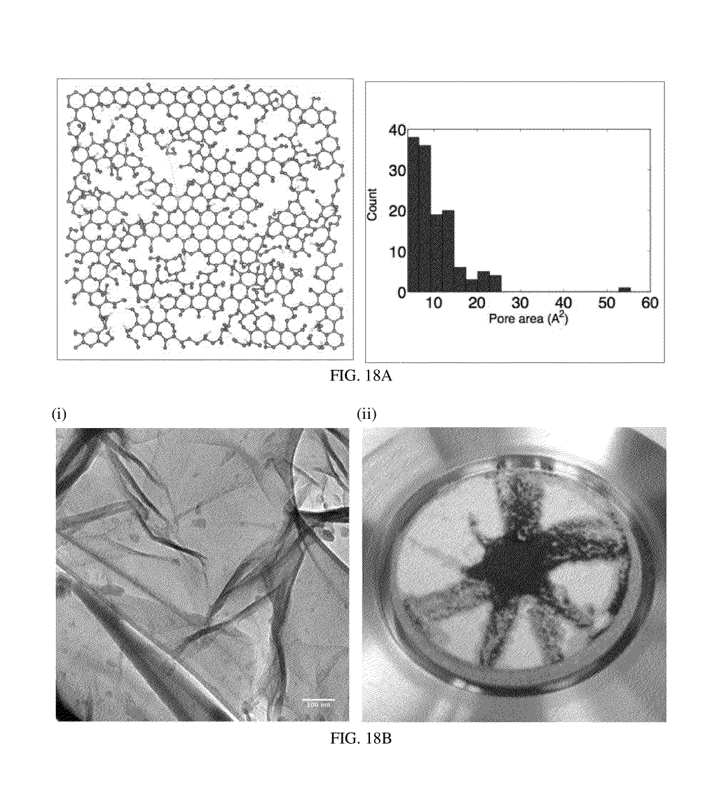

In this example, a computational study suggests that the defects that are initiated by the reduction process of graphene oxide may have an average pore size that is desirable for salt separation. FIG. 18A shows (left) the schematic results of a molecular dynamics simulation of a single layer of graphene oxide that has been reduced in order to remove surface oxygen, shown as a network of bonded carbon, hydrogen and oxygen atoms and the nanoporous network that constitute graphene oxide. The rips in the lattice indicate carbon atoms that have been removed along with those oxygen molecules. The dotted line shows the spacing that was measured as rip size in the sample. FIG. 18A also shows (right) a histogram of the nanopore size distribution in graphene oxide, as measured by the open area (in Å²) of each pore. This computational simulation suggested that the scale of defects initiated was on the order of magnitude as the pores desired for water desalination. The computational study was conducted using the LAMMPS MD code (version 7.8.2013) with the ReaxFF potential for oxygen, hydrogen and carbon atoms.

In order to realize this physically, high resolution images of graphene oxide (GO) and reduced graphene oxide (rGO) flakes were produced through transmission electron microscopy. Samples were prepared by dispersing rGO in IPA and drop casting onto gold Lacey carbon TEM grids. A transfer for CVD graphene can also be conducted by spin-coating PMMA on the surface of the graphene, etching the copper substrate with FeCl₃ and using surface tension to adhere the graphene onto the TEM grid. FIG. 18B shows (i) a TEM image of reduced graphene oxide flake on a holey carbon gold TEM grid. As shown in FIG. 18B(i), rGO flakes did not lie flat when deposited on a surface, and exhibit various defects which will be further characterized. The lighter color in the top right corner shows the area of the grid that is not supported by carbon, and thus a small area of free-standing rGO. FIG. 18B(ii) shows rGO dispersed in toluene spin-coated onto a GE Osmonics AG membrane.

### Example 7

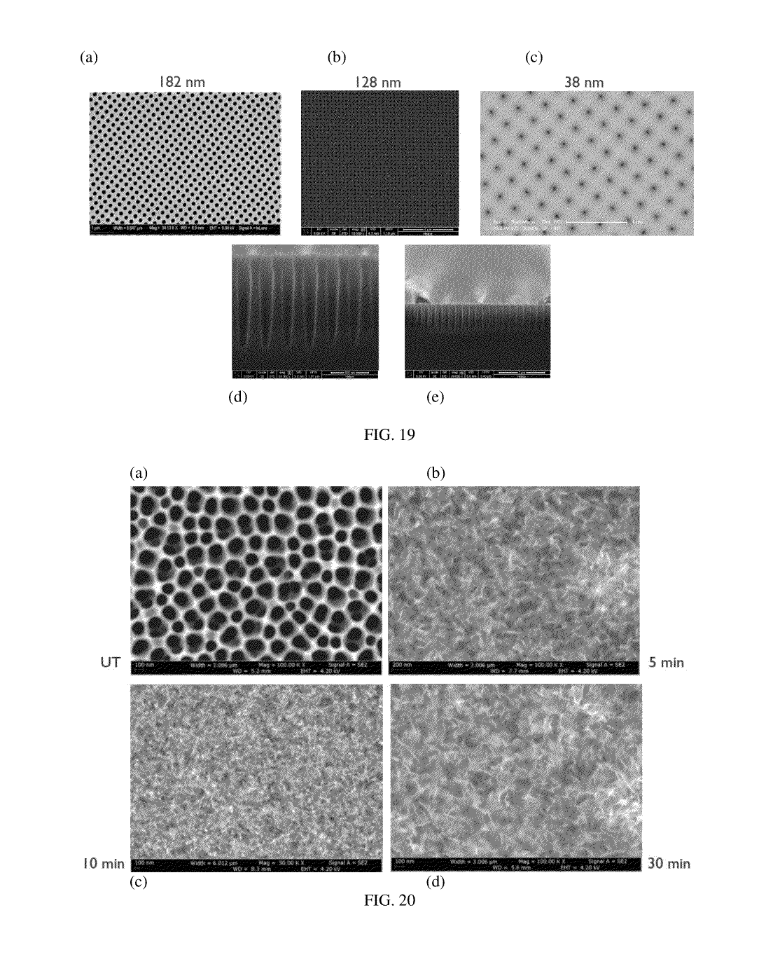

In this example, large-scale silicon manufacturing processes was used to create nanopores in materials, illustrating the reduction of pore size that can occur in silicon through oxide deposition, while maintaining a consistent cross-sectional pore profile. Pores were patterned using interference lithography and etched in 1 micron of amorphous silicon using deep reactive ion etching. (FIG. 19) The average pore diameter was measured to be 182 nm+/−3 nm. (FIG. 19A) High frequency silicon oxide deposition was conducted on flat samples in the PECVD for up to 15 minutes to reduce the pore size to 128 nm (FIG. 19B) and 38 nm (FIG. 19C). Beyond 15 minutes, closing of the pores was observed. The pores remained controllable in size down to a diameter of 38 nanometers, demonstrating a reduction in the diameter by an order of magnitude. At 38 nanometers diameter, the standard deviation remained at 3 nm. In addition, the pore wall profile, shown in the cross-sectional image in FIGS. 19D-E, remained constant.

### Example 8

In this example, anodized aluminum membranes were hydrothermally treated by placing them in boiling deionized water in order to reduce the pore size. FIG. 20 shows SEM images of alumina mounted on carbon tape (a) prior to hydrothermal treatment, and upon hydrothermal treatment for (b) five, (c) ten, and (d) thirty minutes. The images suggest that surface structure rearrangement, and pore narrowing, occurred in all treated membranes.

What is claimed:

1. A method for fabricating a porous material, comprising:
providing a material having a first side and a second, opposing side;
creating a plurality of pores in the material, the plurality of pores spanning the material from the first side to the second, opposing side, and having a first average pore size greater than 1 nanometer;
attaching a moiety to the sidewalls of the pores to produce a porous material comprising a plurality of pores having a second average pore size less than the first average pore size.

2. A method as in claim 1, wherein the second average pore size is in the range of about 1 nm to about 500 nm, about 1 nm to about 100 nm, or about 1 nm to about 10 nm.

3. A method as in claim 1, wherein the second average pore size is in the range of about 6 Å to about 9 Å, or about 7 Å to about 9 Å.

4. A method as in claim 1, wherein the porous material is a metal-containing material.

5. A method as in claim 1, wherein the metal-containing material is silicon.

6. A method as in claim 1, wherein the moiety is a self-assembled monolayer, a hydrophilic group, and/or a hydrophobic group.

7. A method as in claim 6, wherein the self-assembled monolayer comprises a fatty acid, an organosilicon compound, or an organosulfur compound.

8-11. (canceled)

12. A method as in claim 6, wherein the hydrophilic group is hydroxyl or unsubstituted or substituted amino.

13. (canceled)

14. A method as in claim 6, wherein the hydrophobic group is hydrogen, alkyl, aryl, or fluorine.

15. A method as in claim 1, wherein the porous material is configured for filtering a solution and/or desalination.

16. (canceled)

17. A method as in claim 1, wherein the porous material is assembled into a spiral-wound membrane.

18. A method as in claim 1, further comprising:
contacting the first side of the porous material with a solution comprising a fluid carrier and a plurality of species, wherein the pores are sized and/or chemically functionalized to substantially prevent at least a portion of the species from flowing between the first and second sides of the porous material through the pores.

19. A method as in claim 18, wherein the species is an ion and/or a salt.

20. A method as in claim 18, wherein, upon contact with a solution comprising a species, the porous material exhibits a species rejection in the range of about 30% to about 100%, about 40% to about 100%, about 50% to about 100%, about 60% to about 100%, about 70% to about 100%, about 80% to about 100%, about 90% to about 100%.

21-23. (canceled)

24. A method as in claim 1, wherein the porous material has a water permeability in the range of about 0.1 to about 300 L/cm²/day/MPa, about 1 to about 200 L/cm²/day/MPa, about 25 to about 100 L/cm²/day/MPa, about 30 to about 70 L/cm²/day/MPa, or about 36 to about 66 L/cm²/day/MPa.

25. A method as in claim 1, wherein the porous material has a porosity of about 10%, about 25%, or about 50%.

26. A method as in claim 1, wherein the porous material comprises at least one portion having a thickness measured between the first side and the second, opposing side of less than about 500 nm, less than about 400 nm, less than about 300 nm, less than about 200 nm, less than about 100 nm, less than about 50 nm, less than about 25 nm, less than about 10 nm, less than about 5 nm, less than about 1 nm, or less than about 0.1 nm.

27. A method as in claim 1, wherein the porous material comprises at least one portion having a thickness measured between the first side and the second, opposing side of about a single atomic layer.

28. A method as in claim 1, wherein no more than about 50%, no more than about 25%, no more than about 10%, no more than about 5%, or no more than about 1% of all pores deviate in size from the average pore size of the plurality of pores by more than about 5%

29. A method for fabricating a porous material, comprising:
providing a porous material precursor and a fullerene species substantially contained within the porous material precursor, the fullerene species having a diameter;
treating the porous material precursor to remove the fullerene species, thereby producing a porous material comprising a plurality of pores having an average pore size that is substantially similar, or essentially identical, to the diameter of the fullerene species.

30-59. (canceled)

60. A method for fabricating a filtration material, comprising:
exposing a graphene oxide material to a set of reducing conditions to produce a porous graphene material comprising a plurality of pores; and
arranging the porous graphene material as a filtration material.

61. A method as in claim 60, wherein the set of reducing conditions comprises heating the graphene oxide material and/or treating the graphene oxide material with a chemical reagent.

62-69. (canceled)

70. A method as in claim 60, wherein the porous graphene material is configured for filtering a solution and/or desalination.

71-88. (canceled)

89. A material, comprising:
a substrate that is substantially free of pores having a pore size of 5 microns or greater; and
a graphene material arranged on a surface of the substrate,
wherein the material exhibits a mechanical stability characterized by a fracture stress of about 100 GPa or greater when placed under a pressure of about 1 MPa or greater.

90-96. (canceled)
